(19) United States
(12) Patent Application Publication
(10) Pub. No.: US 2026/0128801 A1
(43) Pub. Date: May 7, 2026

(54) SIGNAL PROCESSING METHOD AND SIGNAL PROCESSING DEVICE

(71) Applicant: NEC Corporation, Tokyo (JP)

(72) Inventor: Takahiro ODAGAWA, Tokyo (JP)

(73) Assignee: NEC Corporation, Tokyo (JP)

(21) Appl. No.: 19/357,397

(22) Filed: Oct. 14, 2025

(30) Foreign Application Priority Data
Nov. 1, 2024 (JP) 2024-193241

(51) Int. Cl. H04B 10/61

(52) U.S. Cl. CPC H04B 10/616

(57) ABSTRACT

A signal processing method for converting an input signal sampled at a first rate into an output signal sampled at a second rate in a communication system, includes input/output interval calculation processing of calculating input/output interval data related to a temporal interval between an input sample and an output sample adjacent in the input signal and the output signal, the input/output interval data being able to be shared in calculation of each output sample, based on the first rate and the second rate, coefficient calculation processing of calculating a coefficient sequence used for calculation of an output sample to be calculated based on an input sample around the output sample, and output signal calculation processing of calculating the output sample to be calculated using the input/output interval data and the coefficient sequence.

This application is based upon and claims the benefit of priority from Japanese patent application No. 2024-193241, filed on Nov. 1, 2024, the disclosure of which is incorporated herein in its entirety by reference.

### TECHNICAL FIELD

The present disclosure relates to a signal processing method and a signal processing device.

### BACKGROUND ART

At present, in an optical signal communication system using an optical fiber, a digital coherent technology for compensating and equalizing distortion caused by a transmitter, a receiver and a transmission path by digital signal processing on signal light received by a coherent optical receiver is used.

In order to efficiently process a high-speed and large-capacity signal, it is required to reduce the calculation amount in such digital signal processing. One of the signal processing techniques for reducing the calculation amount is signal processing on a signal (hereinafter, referred to as a fractional oversampled signal) input at a non-integral multiple oversampling rate smaller than 2. For example, M. Arikawa and K. Hayashi, “Frequency-domain adaptive MIMO filter with fractional oversampling using stochastic gradient descent for long-haul transmission over coupled 4-core fibers”. Vol. 31, No. 8/10 Apr. 2023/Optics Express 13104-13124 discloses adaptive multi-input multi-output (MIMO) filter processing on a fractional oversampled signal in a frequency domain.

### SUMMARY

Here, in a general optical signal communication system, signal processing by double oversampling is performed based on the Nyquist condition. For example, in M. Arikawa and K. Hayashi, “Frequency-domain adaptive MIMO filter with fractional oversampling using stochastic gradient descent for long-haul transmission over coupled 4-core fibers”. Vol. 31, No. 8/10 Apr. 2023/Optics Express 13104-13124, as pre-processing, wavelength dispersion compensation and frame synchronization processing are performed on a signal (hereinafter, described as a double oversampled signal) subjected to double oversampling. Thereafter, MIMO processing is performed on the signal converted from the double oversampled signal to the fractional oversampled signal.

As described above, in a case where the pre-processing by the general-purpose double oversampling and the signal processing on the fractional oversampled signal are continuously performed, it is necessary to convert a sampling rate between the two processing. However, there is a problem that a calculation amount increases in order to accurately perform such sampling rate conversion. Such a problem may occur not only in optical signal communication but also in other communication fields.

The present disclosure has been made in view of the above problems, and an exemplary object of the present disclosure is to provide a technique for reducing a calculation amount required for sampling rate conversion in a communication system.

A signal processing method according to one exemplary aspect of the present disclosure, for converting an input signal sampled at a first rate into an output signal sampled at a second rate in a communication system, includes input/output interval calculation processing of calculating input/output interval data related to a temporal interval between an input sample and an output sample adjacent in the input signal and the output signal, the input/output interval data being able to be shared in calculation of each output sample, based on the first rate and the second rate, coefficient calculation processing of calculating a coefficient sequence used for calculation of an output sample to be calculated based on an input sample around the output sample, and output signal calculation processing of calculating the output sample to be calculated using the input/output interval data and the coefficient sequence.

A signal processing device according to one exemplary aspect of the present disclosure, for converting an input signal sampled at a first rate into an output signal sampled at a second rate in a communication system, the signal processing device includes input/output interval calculation means for calculating input/output interval data related to a temporal interval between an input sample and an output sample adjacent in the input signal and the output signal, the input/output interval data being able to be shared in calculation of each output sample, based on the first rate and the second rate, coefficient calculation means for calculating a coefficient sequence used for calculation of an output sample to be calculated based on an input sample around the output sample, and output signal calculation means for calculating the output sample to be calculated using the input/output interval data and the coefficient sequence.

According to an exemplary aspect of the present disclosure, it is possible to provide a technique for reducing a calculation amount required for sampling rate conversion in a communication system.

### BRIEF DESCRIPTION OF THE DRAWINGS

FIG. 1 is a flowchart illustrating a flow of a signal processing method according to the present disclosure;

FIG. 2 is a block diagram illustrating a configuration of a signal processing device according to the present disclosure;

FIG. 3A and FIG. 3B are diagrams illustrating a sampling rate conversion result by general linear interpolation and spline interpolation;

FIG. 4 is a block diagram illustrating a configuration of a signal processing device according to the present disclosure;

FIG. 5 is a block diagram illustrating a detailed configuration of a coefficient calculation unit according to the present disclosure;

FIG. 6 is a block diagram illustrating a detailed configuration of an output signal calculation unit according to the present disclosure;

FIG. 7 is a schematic diagram illustrating an example of input/output interval data of a plurality of patterns according to the present disclosure;

FIG. 8 is a diagram illustrating an example of input/output interval data of a plurality of patterns according to the present disclosure;

FIG. 9 is a flowchart illustrating a flow of a signal processing method according to the present disclosure;

FIG. 10 is a block diagram illustrating a configuration of a signal processing device according to the present disclosure;

FIG. 11 is a block diagram illustrating a detailed configuration of a coefficient calculation unit according to the present disclosure;

FIG. 12 is a diagram illustrating an example of input/output interval data including a constant multiple according to the present disclosure;

FIG. 13 is a diagram illustrating an example of input/output interval data including a constant multiple according to the present disclosure;

FIG. 14 is a flowchart illustrating a flow of a signal processing method executed by the signal processing device according to the present disclosure;

FIG. 15 is a block diagram illustrating a configuration of the signal processing device according to the present disclosure;

FIG. 16 is a block diagram illustrating a detailed configuration of an output signal calculation unit according to the present disclosure;

FIG. 17 is a flowchart illustrating a flow of a signal processing method according to the present disclosure;

FIG. 18 is a block diagram illustrating a configuration of a signal processing device according to the present disclosure;

FIG. 19 is a flowchart illustrating a flow of a signal processing method according to the present disclosure;

FIG. 20 is a block diagram illustrating a configuration of a signal processing device according to the present disclosure;

FIG. 21 is a schematic diagram illustrating a specific example of a signal processing device according to the present disclosure;

FIG. 22 is a flowchart illustrating a flow of a signal processing method according to the present disclosure;

FIG. 23 is a block diagram illustrating a configuration of an optical signal communication system according to the present disclosure;

FIG. 24 is a block diagram illustrating a configuration of an optical signal communication system according to the present disclosure; and

FIG. 25 is a block diagram illustrating a hardware configuration of a computer that functions as each of the signal processing devices.

### EXAMPLE EMBODIMENT

Hereinafter, example embodiments of the present invention will be exemplified. However, the present invention is not limited to the following exemplary embodiments, and various modifications can be made within a scope described in the claims. For example, example embodiments obtained by appropriately combining technologies (some or all of things or methods) adopted in the following exemplary embodiments can also be included in the scope of the present invention. Example embodiments obtained by appropriately omitting some of the technologies adopted in the following exemplary embodiments can also be included in the scope of the present invention. Effects mentioned in the following exemplary embodiments are examples of effects expected in the exemplary embodiments, and do not define the scope of the present invention. In other words, example embodiments that do not provide the effects mentioned in the following exemplary embodiments can also be included in the scope of the present invention.

### First Exemplary Embodiment

A first exemplary embodiment that is an example of the example embodiments of the present invention will be described in detail with reference to the drawings. The present exemplary embodiment is a basic form of each exemplary embodiment to be described below. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technology illustrated in the drawings referred to for describing the present exemplary embodiment can also be adopted in another exemplary embodiment included in the present disclosure within a range in which no particular technical problem occurs.

### (Flow of Signal Processing Method S1)

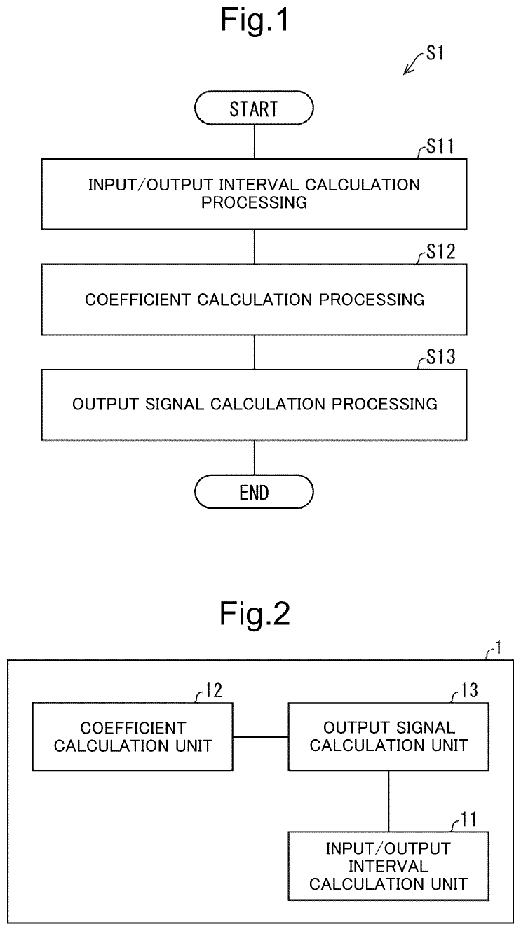

A flow of a signal processing method S1 will be described with reference to FIG. 1. FIG. 1 is a flowchart illustrating a flow of the signal processing method S1. The signal processing method S1 is a method for converting an input signal sampled at a first rate into an output signal sampled at a second rate in a communication system. The signal processing method S1 may be used, for example, for sampling rate conversion of a reception signal in a communication system. In other words, the signal processing method S1 may be executed by, for example, a signal processing device that processes a reception signal in a communication system.

As illustrated in FIG. 1, the signal processing method S1 includes input/output interval calculation processing S11, coefficient calculation processing S12, and output signal calculation processing S13.

The input/output interval calculation processing S11 is processing of calculating input/output interval data regarding a temporal interval between an input sample and an output sample adjacent in the input signal and the output signal, which can be shared in calculation of each output sample, based on the first rate and the second rate. Here, the input sample indicates each signal point configuring the input signal being sampled. The output sample indicates each signal point to configure the output signal. The calculated input/output interval data is held in a storage unit (not illustrated).

The coefficient calculation processing S12 is processing of calculating a coefficient sequence used for calculation of the output sample based on input samples around the output sample to be calculated. Hereinafter, the “input samples around the output sample to be calculated” is also simply referred to as “surrounding input samples”. The surrounding input samples include input samples at least immediately before and immediately after the output sample to be calculated. The surrounding input samples may include a plurality of input samples before the to-be-calculated output sample, or may include a plurality of input samples after the to-be-calculated output sample.

The output signal calculation processing S13 is processing of calculating an output sample to be calculated using the input/output interval data and the coefficient sequence. For example, the output signal calculation processing S13 calculates the output sample using an interpolation expression for interpolating a section including the output sample to be calculated based on the surrounding input samples. As the interpolation expression, an expression based on a known interpolation method can be applied. Such an interpolation expression includes or is modified to include input/output interval data that can be shared in calculation of each output sample and a coefficient sequence that can be different depending on the output sample.

Here, a temporal interval between any input samples and output samples adjacent to each other in the input signal and the output signal having different sampling rates is determined in a plurality of patterns according to a combination of the first rate of the input signal and the second rate of the output signal. Therefore, the input/output interval data regarding the interval can be shared in the calculation of each output sample having the same pattern. Therefore, in the output signal calculation processing S13, the input/output interval data held in the storage unit is referred to.

### (Effect of Signal Processing Method S1)

As described above, in the signal processing method S1, the signal processing method for converting an input signal sampled at a first rate into an output signal sampled at a second rate in a communication system, includes input/output interval calculation processing S11 of calculating input/output interval data related to a temporal interval between an input sample and an output sample adjacent in the input signal and the output signal, the input/output interval data being able to be shared in calculation of each output sample, based on the first rate and the second rate, coefficient calculation processing S12 of calculating a coefficient sequence used for calculation of an output sample to be calculated based on an input sample around the output sample, and output signal calculation processing S13 of calculating the output sample to be calculated using the input/output interval data and the coefficient sequence. Therefore, according to the signal processing method S1, it is not necessary to calculate the input/output interval data for each output sample. As a result, it is possible to reduce the calculation amount required for sample rate conversion from the input signal of the first rate to the output signal of the second rate in the communication system.

### (Configuration of Signal Processing Device 1)

A configuration of the signal processing device 1 will be described with reference to FIG. 2. FIG. 2 is a block diagram illustrating a configuration of the signal processing device 1. The signal processing device 1 is a device that executes the signal processing method S1 described above. The signal processing device 1 converts an input signal sampled at a first rate in the communication system into an output signal sampled at a second rate. For example, the signal processing device 1 may be a device that processes a reception signal in a communication system.

As illustrated in FIG. 1, the signal processing device 1 includes an input/output interval calculation unit 11, a coefficient calculation unit 12, and an output signal calculation unit 13. Here, the input/output interval calculation unit 11 is an example of a configuration that implements input/output interval calculation means. The coefficient calculation unit 12 is an example of a configuration that achieves a coefficient calculation means. The output signal calculation unit 13 is an example of a configuration that achieves an output signal calculation means. A part or all of the input/output interval calculation unit 11, the coefficient calculation unit 12, and the output signal calculation unit 13 may be achieved by a general-purpose or dedicated circuit. The circuit may be configured by a single chip or may be configured by a plurality of chips connected via a bus. Some or all of the input/output interval calculation unit 11, the coefficient calculation unit 12, and the output signal calculation unit 13 may be achieved by at least one processor executing a program.

The input/output interval calculation unit 11 calculates input/output interval data regarding a temporal interval between an input sample and an output sample adjacent in the input signal and the output signal, which can be shared in calculation of each output sample, based on the first rate and the second rate. The coefficient calculation unit 12 calculates a coefficient sequence used for calculation of the output sample based on input samples around the output sample to be calculated. The output signal calculation unit 13 calculates an output sample to be calculated using the input/output interval data and the coefficient sequence.

### (Effects of Signal Processing Device 1)

As described above, in the signal processing device 1, the signal processing device for converting an input signal sampled at a first rate into an output signal sampled at a second rate in a communication system, includes an input/output interval calculation unit 11 for calculating input/output interval data related to a temporal interval between an input sample and an output sample adjacent in the input signal and the output signal, the input/output interval data being able to be shared in calculation of each output sample, based on the first rate and the second rate, a coefficient calculation unit 12 for calculating a coefficient sequence used for calculation of an output sample to be calculated based on an input sample around the output sample, and an output signal calculation unit 13 for calculating the output sample to be calculated using the input/output interval data and the coefficient sequence. Therefore, according to the signal processing device 1, it is not necessary to calculate the input/output interval data for each output sample. As a result, it is possible to reduce the calculation amount required for sample rate conversion from the input signal of the first rate to the output signal of the second rate in the communication system.

### Second Exemplary Embodiment

A second exemplary embodiment that is an example of the example embodiments of the present invention will be described in detail with reference to the drawings. Components that have the same functions as the components described in the above-described exemplary embodiment are denoted by the same reference signs, and description of the components will be appropriately omitted. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technique illustrated in each of the drawings referred to for describing the present exemplary embodiment can be adopted in the other exemplary embodiments included in the present disclosure within a range in which no particular technical problem occurs.

### Specific Example of Problem of General Sampling Rate Conversion Processing

A specific example of the problem in the general sampling rate conversion processing will be described below.

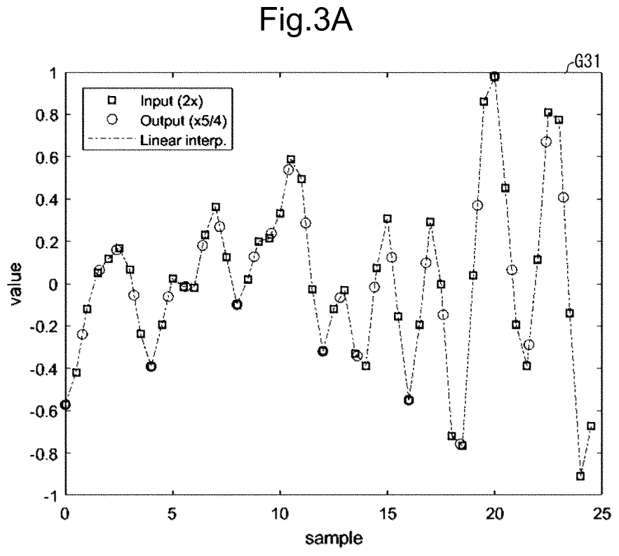

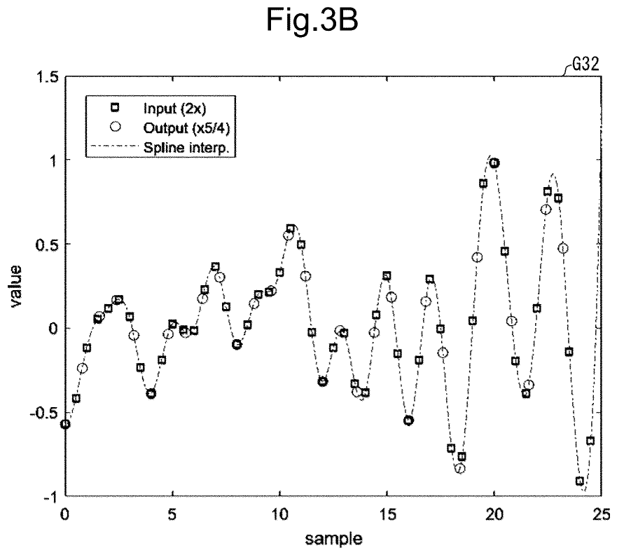

As the sampling rate conversion processing, a method of calculating the size of the output sample based on an interpolation expression for interpolating between adjacent input samples can be considered. An example of interpolation is linear interpolation. Another example of interpolation is interpolation using a curve such as spline interpolation. FIG. 3A and FIG. 3B are diagrams illustrating a result of sampling rate conversion of a double oversampled signal into a 5/4 times oversampled signal using linear interpolation and spline interpolation. In FIG. 3A, a graph G31 illustrates a sampling rate conversion result by linear interpolation. In FIG. 3B, a graph G32 illustrates a sampling rate conversion result by spline interpolation. In the graphs G31 and G32, rectangles represent input samples, circles represent output samples, and dotted lines represent interpolation expressions.

As illustrated in the graph G31, in the case of using linear interpolation, each of adjacent input samples is interpolated with a straight line, and an output sample is calculated as a point on each straight line. As illustrated in the graph G32, in a case where spline interpolation is used, interpolation is performed between adjacent input samples by a polynomial of a high order (generally, 3 or higher order), and an output sample is calculated as a curved point according to the high-order polynomial.

Here, linear interpolation has a problem that a signal is greatly deteriorated. Spline interpolation suppresses signal degradation as compared with linear interpolation, but there is a problem that the calculation amount required for sampling rate conversion increases.

More specifically, in spline interpolation, it is known that interpolation can be sufficiently performed even if a high-order polynomial is obtained using not all input samples but only the periphery of a section to be interpolated.

At this time, a high-order polynomial that interpolates the section (n, n+1] is expressed by the following Expression (1).

$$\begin{matrix}[ Ex . 1 ] & \\ {s}_{n} ( x ) = {a}_{n} + {b}_{n} ( x - {x}_{n} ) + {{c}_{n} ( x - {x}_{n} )}^{2} + {{d}_{n} ( x - {x}_{n} )}^{3} & ( 1 )\end{matrix}$$

In Expression (1), n represents the n-th input sample. Sampling time point x indicates any time point included in sampling time point x_n+1 from more than sampling time point x_n. In the present specification, a symbol “_” in “_n” or the like indicates that a subsequent character “n” or the like is a subscript. As described above, in a case where the sampling rate conversion processing is performed using the high-order polynomial of Expression (1), calculation for obtaining a_n, b_n, c_n, d_n, (x−x_n), the square of (x−x_n), and the cube of (x-x_n) is generated for each output sample. Therefore, there is a problem that the calculation amount increases.

### (Outline of Signal Processing Device 1A)

The signal processing device 1A according to the present exemplary embodiment is an aspect obtained by modifying the signal processing device 1 according to the first exemplary embodiment. An outline of the idea of the inventor according to the aspect will be described.

In a case where the output sample S_n(x_o) at the sampling time point x_o is calculated using the above-described Expression (1), the interval value (x_o−x_n) indicating the temporal interval between the output sample and the immediately preceding input sample is determined to be any of a plurality of patterns by a combination of the sampling rate of the input signal and the sampling rate of the output signal. Therefore, the interval value and the power of the interval value can be shared in the calculation of each output sample. For example, the interval value (x−x_n), the square of (x−x_n), and the cube of (x−x_n) in Expression (1) can be shared in calculation of each output sample having the same interval with the immediately preceding input sample.

Therefore, in order to reduce the calculation amount required for the sampling rate conversion using the high-order polynomial, the inventor has obtained an idea of previously calculating and holding the interval value and the power of the interval value, and sharing the held interval value and the power of the interval value in the calculation of each output sample. The signal processing device 1A is an aspect of the present invention based on the idea.

### (Configuration of Signal Processing Device 1A)

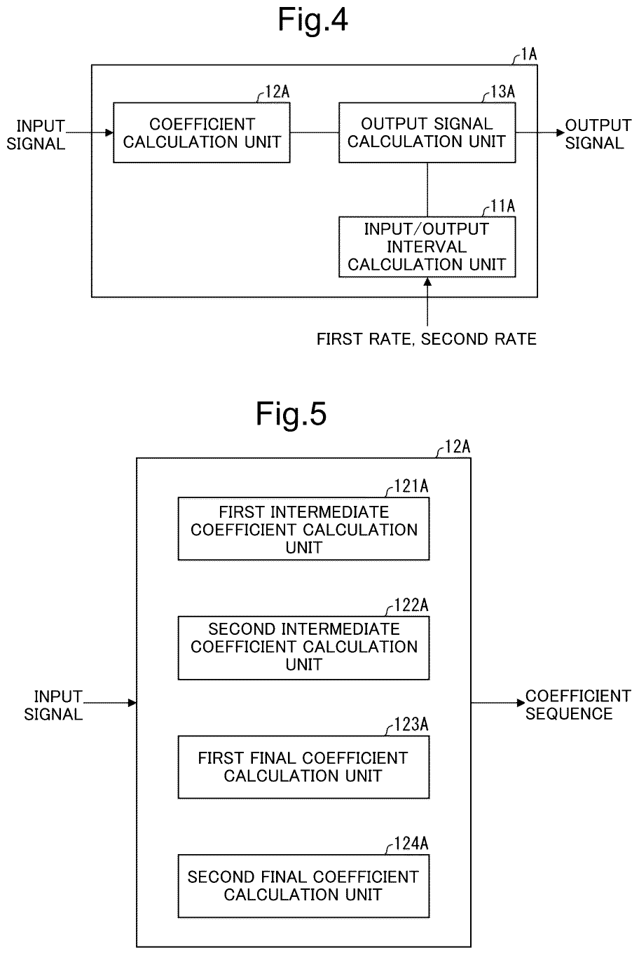

FIG. 4 is a block diagram illustrating a configuration of the signal processing device 1A. As illustrated in FIG. 4, the signal processing device 1A includes an input/output interval calculation unit 11A, a coefficient calculation unit 12A, and an output signal calculation unit 13A. In each of the drawings of the present specification including FIG. 4, a unidirectional arrow indicates a flow direction of a certain signal, and does not exclude bidirectionality.

(Input/output interval calculation unit 11A)

The input/output interval calculation unit 11A is configured as follows in addition to being configured similarly to the input/output interval calculation unit 11 in the first exemplary embodiment. The input/output interval calculation unit 11A calculates the input/output interval data for each of the intervals of the plurality of patterns of the adjacent input sample and output sample with reference to the first rate and the second rate. The calculated input/output interval data of the plurality of patterns is held in a storage unit (not illustrated).

The input/output interval calculation unit 11A calculates, as the input/output interval data, an interval value indicating an interval and a power of the interval value included in a high-order polynomial that interpolates at least two input samples by interpolation with a curve. The interpolation with curves may be, for example, the spline interpolation, but is not limited thereto.

The input/output interval calculation unit 11A applies (i) an interval between an output sample and an input sample immediately before the output sample or (ii) an interval between an output sample and an input sample immediately after the output sample as an interval between adjacent input samples and output samples. Hereinafter, an example in which the above-described (i) is applied as the “interval between adjacent input samples and output samples” will be mainly described, but in a case where the above-described (ii) is applied, the same description will be given by replacing “immediately before” with “immediately after” in the following description. The combination of (i) and (ii) described above may be applied as the “interval between adjacent input samples and output samples”.

### (Coefficient Calculation Unit 12A)

The coefficient calculation unit 12A is configured as follows in addition to being configured similarly to the coefficient calculation unit 12 in the first exemplary embodiment. The coefficient calculation unit 12A calculates a coefficient related to the interval value and a coefficient related to the power of the interval value as a coefficient sequence associated with the output sample to be calculated.

FIG. 5 is a block diagram illustrating a detailed configuration of the coefficient calculation unit 12A. As shown in FIG. 5, the coefficient calculation unit 12A includes a first intermediate coefficient calculation unit 121A, a second intermediate coefficient calculation unit 122A, a first final coefficient calculation unit 123A, and a second final coefficient calculation unit 124A.

The first intermediate coefficient calculation unit 121A calculates a first intermediate coefficient with reference to surrounding input samples. The first intermediate coefficient is a coefficient referred to for obtaining a second intermediate coefficient to be described later. Here, it is desirable that the surrounding input samples include two or more input samples before and after the output signal to be calculated.

The second intermediate coefficient calculation unit 122A calculates the second intermediate coefficient with reference to the first intermediate coefficient. The second intermediate coefficient is a coefficient referred to for obtaining a first final coefficient to be described later.

The first final coefficient calculation unit 123A calculates the first final coefficient with reference to the second intermediate coefficient. The first final coefficient is a coefficient applied according to an output sample to be calculated in a high-order polynomial interpolating at least two input samples with a curve.

The second final coefficient calculation unit 124A calculates the second final coefficient with reference to the surrounding input samples and the first final coefficient. The second final coefficient is a coefficient applied according to an output sample to be calculated in a high-order polynomial interpolating at least two input samples with a curve.

### (Output Signal Calculation Unit 13A)

The output signal calculation unit 13A is configured as follows in addition to being configured similarly to the output signal calculation unit 13 in the first exemplary embodiment. The output signal calculation unit 13A executes processing using a high-order polynomial that interpolates at least two input samples with a curve.

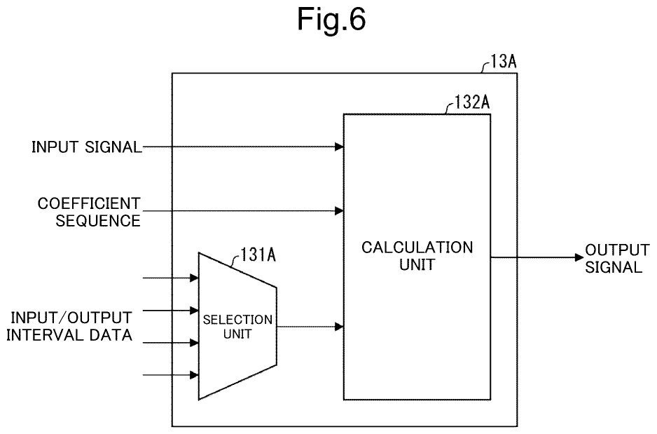

FIG. 6 is a block diagram illustrating a detailed configuration of the output signal calculation unit 13A. As illustrated in FIG. 6, the output signal calculation unit 13A includes a selection unit 131A and a calculation unit 132A.

The selection unit 131A selects input/output interval data used to calculate an output sample to be calculated from among a plurality of patterns of input/output interval data. For example, the selection unit 131A selects input/output interval data of a pattern associated with an interval between an output sample to be calculated and an input sample immediately before the output sample.

The calculation unit 132A calculates and outputs the output sample using the surrounding input samples, the first final coefficient and the second final coefficient calculated by the coefficient calculation unit 12A, and the input/output interval value data selected by the selection unit 131A.

### Specific Example

Next, specific examples of the input/output interval calculation unit 11A, the coefficient calculation unit 12A, and the output signal calculation unit 13A will be described. For example, each of the input/output interval calculation unit 11A, the coefficient calculation unit 12A, and the output signal calculation unit 13A may be configured by a circuit such as a field programmable gate array (FPGA) or an application specific integration circuit (ASIC).

### Specific Example of Input/Output Interval Calculation Unit 11A

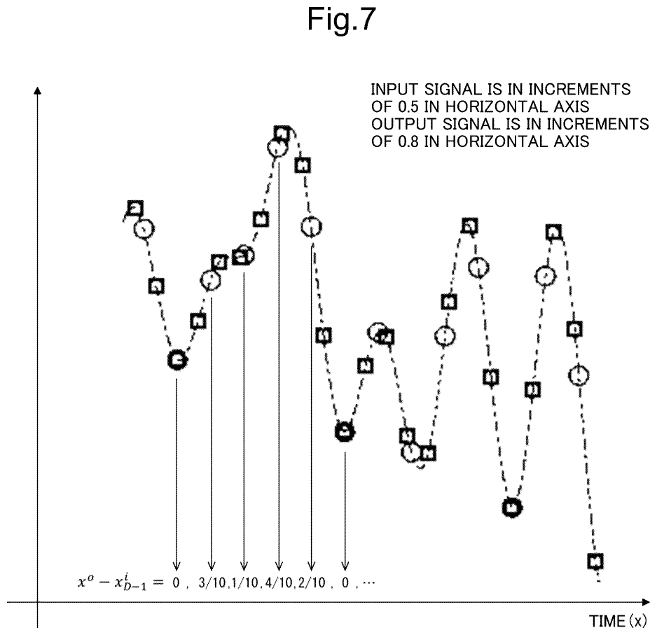

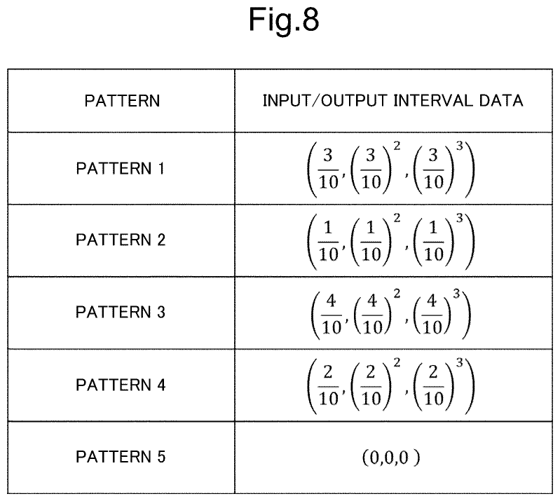

A specific example of the input/output interval calculation processing by the input/output interval calculation unit 11A will be described with reference to FIGS. 7 to 8. In the present specific example, as an example, the first rate is 2, and the second rate is 5/4. The notation “m/n” indicates a fraction with a numerator of m and a denominator of n. As an example, “an interval between an output sample and an input sample immediately before the output sample” is applied as an interval between adjacent input samples and output samples.

FIG. 7 is a schematic diagram illustrating an example of input/output interval data of a plurality of patterns. In FIG. 7, the horizontal axis represents time, and the vertical axis represents a signal value. Rectangles indicate input samples, and circles indicate output samples. The sampling time point x\hat{ }i of each input sample is in increments of 0.5, and the sampling time point x\hat{ }o of each output sample is in increments of 0.8. Here, in the present specification, “\hat{ }” in notations such as “\hat{ }i” and “\hat{ }o” indicates that the following characters “i”, “o”, and the like are superscript characters. The reference numerals 0.5 and 0.8 denote relative sizes with respect to a reference time width.

As illustrated in FIG. 7, an interval between the sampling time point x\hat{ }o of the output sample and the sampling time point x\hat{ }i_(D−1) of the input sample immediately before the output sample is periodically repeated in five patterns of 3/10, 1/10, 4/10, 2/10, and 0. Therefore, the input/output interval data associated with these five patterns is calculated. FIG. 8 is a diagram illustrating an example of input/output interval data of a plurality of patterns. As illustrated in FIG. 8, the input/output interval data of Pattern 1 includes 3/10 which is an interval value, the square of 3/10, and the cube of 3/10. Similarly, the input/output interval data of each of the patterns 2 to 4 includes an interval value (1/10, 4/10, or 2/10), the square of the interval value, and the cube of the interval value. Since the interval value is 0, the input/output interval data of the pattern 5 includes 0 as the interval value, the square of the interval value, and the cube of the interval value.

The input/output interval data is not limited to the example in which the first rate is 2 and the second rate is 5/4 as illustrated in FIGS. 7 to 8. The number of patterns of the interval between the adjacent input samples and output samples and the input/output interval data of each pattern are determined according to a combination of the first rate and the second rate.

### Specific Example of Coefficient Calculation Unit 12A

A specific example of coefficient calculation processing by the coefficient calculation unit 12A will be described. Here, in a case where Expression (1) is applied as an example of a high-order polynomial, c_n is an example of a first final coefficient, and b_n and d_n are examples of a second final coefficient.

Hereinafter, the output sample to be calculated is represented as (x\hat{ }o, y\hat{ }o). x\hat{ }o represents a sampling time point of the output sample, and y\hat{ }o represents a value of the output sample. A parameter for determining how many input samples before and after the output sample (x\hat{ }o, y\hat{ }o) to be calculated are used to perform the coefficient calculation processing is represented as D. D is a natural number of 2 or more.

The k-th input sample among the input samples of each of D points before and after the output sample (x\hat{ }o, y\hat{ }o) to be calculated is represented as (x\hat{ }i_k, y\hat{ }i_k). x\hat{ }i_k represents a sampling time point of the input sample, and y\hat{ }i_k represents a value of the input sample. In other words, the input sample at the front D-th point of the output sample (x\hat{ }o, y\hat{ }o) is set as k=0-th, k is added one by one from the front to the rear input sample, and the input sample at the rear D-th point is set as k=2D-1-th.

The first intermediate coefficient calculation unit 121A calculates the first intermediate coefficient α_k using, for example, the following Expressions (2) and (3). As shown in Expressions (2) and (3), in the calculation of the first intermediate coefficient α_k, the surrounding input sample a_k is referred to. The surrounding input samples a_k represent input samples of D points before and after the output sample to be calculated.

$$\begin{matrix}[ Ex . 2 ] & \\ {a}_{k} = {y}_{k}^{i} ( k = 0 , 1 , … 2 D - 1 ) & ( 2 )\end{matrix}$$

$$\begin{matrix}[ Ex . 3 ] & \\ for k = 1 , 2 , … 2 D - 2 & \end{matrix}$$

$${a}_{k} = 6 ( {a}_{k + 1} - 2 {a}_{k} + {a}_{k - 1} ) \qquad ( 3 )$$

The second intermediate coefficient calculation unit 122A calculates the second intermediate coefficients z_k, μ_k, and 1_k by using, for example, the following Expressions (4) to (7). As shown in Expressions (4) to (7), the first intermediate coefficient α_k is referred to in the calculation of the second intermediate coefficients z_k, μ_k, and 1_k.

$$\begin{matrix}[ Ex . 4 ] & \\ {l}_{0} = {l}_{2 D - 1} = 1 & ( 4 )\end{matrix}$$

$$\begin{matrix}[ Ex . 5 ] & \\ {μ}_{0} = {μ}_{2 D - 1} = 0 & ( 5 )\end{matrix}$$

$$\begin{matrix}[ Ex . 6 ] & \\ {z}_{0} = {z}_{2 D - 1} = 0 & ( 6 )\end{matrix}$$

$$\begin{matrix}[ Ex . 7 ] & \\ for k = 1 , 2 , … 2 D - 2 & \end{matrix}$$

$${l}_{k} = 2 - \frac{1}{2} {μ}_{k - 1} , {μ}_{k} = \frac{1}{2 {l}_{k}} , {z}_{k} = ( {α}_{k} - 0.5 {z}_{k - 1} ) / {l}_{k} \qquad ( 7 )$$

The first final coefficient calculation unit 123A calculates the first final coefficient c_k using, for example, the following Expressions (8) and (9). As shown in the Expressions (8) and (9), the second intermediate coefficients z_k and μ_k are referred to in the calculation of the first final coefficient c_k.

$$\begin{matrix}[ Ex . 8 ] & \\ {c}_{2 D - 1} = 0 & ( 8 )\end{matrix}$$

$$\begin{matrix}[ Ex . 9 ] & \\ for k = 2 D - 2 , 2 D - 1 , … D - 1 & \end{matrix}$$

$${c}_{k} = {z}_{k} - {μ}_{k} {c}_{k + 1} \qquad ( 9 )$$

The second final coefficient calculation unit 124A calculates the second final coefficients b and d, for example, using the following Expressions (10) and (11). As shown in Expressions (10) and (11), in the calculation of the second final coefficients b and d, the surrounding input sample a_k and the first final coefficient c_k are referred to.

$$\begin{matrix}[ Ex . 10 ] & \\ b = 2 ( {a}_{D} - {a}_{D - 1} ) - \frac{1}{6} ( {c}_{D} + 2 {c}_{D - 1} ) & ( 10 )\end{matrix}$$

$$\begin{matrix}[ Ex . 11 ] & \\ d = \frac{2}{3} ( {c}_{D} - {c}_{D - 1} ) & ( 11 )\end{matrix}$$

Here, the method of calculating the coefficient in the coefficient calculation processing is not limited to the example of the above Expressions (2) to (11). For example, the calculation of the coefficients does not need to be performed in the order of the above-described expressions, and the coefficients may be calculated by being replaced in the order in which the same result is obtained, or may be corrected within a range in which the effect of the resampling can be obtained. As an example of correction, for example, μ_k in Expressions (7) and (9) may be fixed to a finally converging value. Examples of the value to be fixed include, but are not limited to, the value shown in the following Expression (12). In addition, some or all of the coefficients in Expressions (2) to (11) may be replaced with empirically obtained values.

$$\begin{matrix}[ Ex . 12 ] & \\ {μ}_{k} = \frac{2}{( 2 - \sqrt{3} )} & ( 12 )\end{matrix}$$

### Specific Example of Output Signal Calculation Unit 13A

A specific example of the output signal calculation processing by the output signal calculation unit 13A will be described. For example, the output signal calculation unit 13A calculates the value y\hat{ }o of the output sample to be calculated using the following Expression (13) which is a high-order polynomial. As shown in Expression (13), in the calculation of the output sample, the coefficients b, c_k, and d calculated according to the output sample and the input/output interval data (interval value, square of interval value, and cube of interval value) of an appropriate pattern among the plurality of patterns of input interval data held in the storage unit are referred to. For example, the reference input/output interval data is input/output interval data of a pattern according to the interval between the output sample (x\hat{ }o, y\hat{ }o) and the immediately preceding input sample among the five patterns of input/output interval data illustrated in FIG. 8.

$$\begin{matrix}[ Ex . 13 ] & \\ {y}^{o} = {a}_{D - 1} + b ( {x}^{o} - {x}_{D - 1}^{i} ) + {{c}_{D - 1} ( {x}^{o} - {x}_{D - 1}^{i} )}^{2} + {d ( {x}^{o} - {x}_{D - 1}^{i} )}^{3} & ( 13 )\end{matrix}$$

### (Flow of Signal Processing Method S1A)

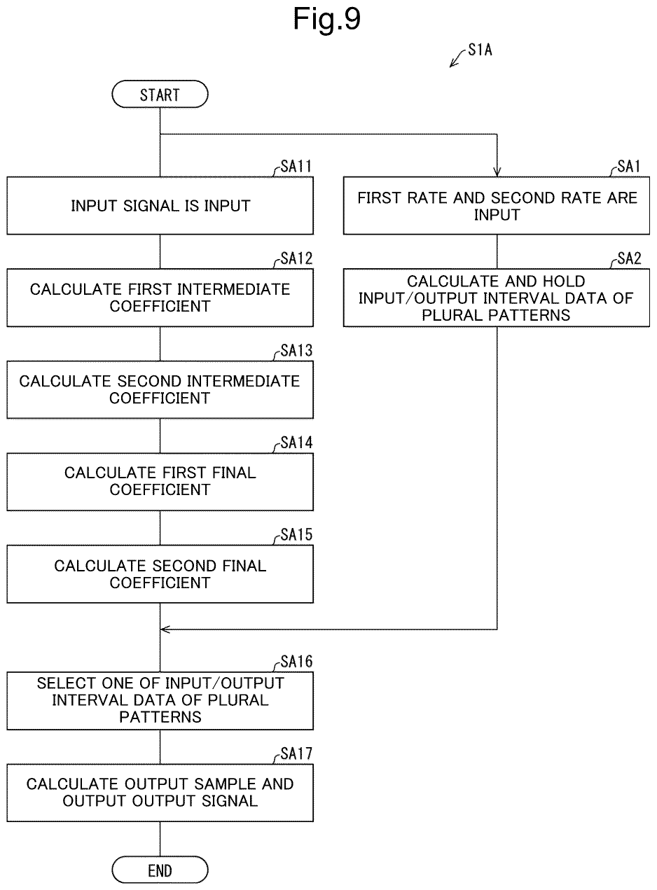

FIG. 9 is a flowchart illustrating a flow of the signal processing method SIA executed by the signal processing device 1A. As illustrated in FIG. 9, the signal processing method SIA includes steps SA1 to SA2 and SA11 to SA17. Steps SA1 and SA2 may be executed at least once. Steps SA11 to SA17 are repeatedly executed for each calculation of the output sample.

In step SA1, the first rate and the second rate are input to the input/output interval calculation unit 11A. In step SA2, the input/output interval calculation unit 11A calculates a plurality of patterns of input/output interval data based on the first rate and the second rate. The calculated input/output interval data is held in the storage unit. As a result, it is not necessary to perform the processing of steps SA1 to SA2 for each calculation of the output sample, and thus, the calculation amount is reduced.

In step SA11, an input signal is input to the coefficient calculation unit 12A. For example, the input samples configuring the input signal are sequentially input.

In step SA12, the first intermediate coefficient calculation unit 121A calculates the first intermediate coefficient with reference to the surrounding input samples, and inputs the first intermediate coefficient to the second intermediate coefficient calculation unit 122A. For example, in order to calculate the first intermediate coefficient, the above-described Expressions (2) to (3) may be used, but the present invention is not limited thereto.

In step SA13, the second intermediate coefficient calculation unit 122A refers to the first intermediate coefficient to calculate the second intermediate coefficient, and inputs the second intermediate coefficient to the first final coefficient calculation unit 123A. For example, in order to calculate the second intermediate coefficient, the above-described Expressions (4) to (7) may be used, but the present invention is not limited thereto.

In step SA14, the first final coefficient calculation unit 123A refers to the second intermediate coefficient to calculate the first final coefficient, and inputs the first final coefficient to the second final coefficient calculation unit 124A and the output signal calculation unit 13A. For example, in order to calculate the first final coefficient, the above-described Expressions (8) to (9) may be used, but the present invention is not limited thereto.

In step SA15, the second final coefficient calculation unit 124A calculates the second final coefficient with reference to the surrounding input samples and the first final coefficient, and inputs the second final coefficient to the output signal calculation unit 13A. For example, Expressions (10) to (11) described above may be used to calculate the second final coefficient, but the present invention is not limited thereto.

In step SA16, the selection unit 131A selects input/output interval data of a pattern associated with an output sample to be calculated from among a plurality of patterns of input/output interval data held in the storage unit.

In step SA17, the calculation unit 132A calculates and outputs an output sample using the surrounding input samples, the selected input/output interval data, and the first final coefficient and the second final coefficient. For example, Expression (13) described above may be used to calculate the output sample, but is not limited thereto.

Steps SA11 to SA17 are repeated in order to calculate the next calculation target output sample. As a result, output samples are sequentially output to configure an output signal.

### Effects of Present Exemplary Embodiment

As described above, in the signal processing device 1A and the signal processing method S1A, the output signal calculation processing by the output signal calculation unit 13A uses a high-order polynomial that interpolates at least two input samples by interpolation with a curve, and the input/output interval calculation processing by the input/output interval calculation unit 11A employs a configuration in which an interval value indicating an interval and a power of the interval value included in the high-order polynomial are calculated as the input/output interval data. Therefore, according to the signal processing device 1A and the signal processing method S1A, it is possible to reduce the calculation amount while accurately performing the conversion processing of the sample rate of the signal in the communication system by interpolation of the curve.

In the signal processing device 1A and the signal processing method S1A, the input/output interval calculation processing by the input/output interval calculation unit 11A employs a configuration in which the interval between the output sample and the input sample immediately before the output sample or the interval between the output sample and the input sample immediately after the output sample is applied as the interval between the adjacent input sample and output sample. Therefore, according to the signal processing device 1A and the signal processing method S1A, it is possible to flexibly set from which of the recurrence expressions for the second intermediate coefficient and the first final coefficient is started (in other words, whether the calculation is performed while increasing k or decreasing k).

In a case where both the interval with the immediately preceding input sample and the interval with the immediately succeeding input sample are applied in combination, there is a possibility that the calculation amount and the holding amount of the input/output interval data can be further reduced. For example, it is assumed that, among the five patterns illustrated in FIG. 8, the interval with the immediately preceding input sample is applied in pattern 1 and pattern 2, and the interval with the immediately succeeding input sample is applied in pattern 3 and pattern 4. In this case, the input/output interval data is the same in pattern 1 and pattern 4, and the input/output interval data is the same in pattern 2 and pattern 3. As a result, the calculation amount and the holding amount of the input/output interval data can be further reduced.

In the signal processing device 1A and the signal processing method S1A, a configuration is adopted in which the input/output interval calculation processing by the input/output interval calculation unit 11A calculates the input/output interval data for each of the intervals of the plurality of patterns, and the output signal calculation processing by the output signal calculation unit 13A selects the input/output interval data to be used for calculating the output sample to be calculated from the input/output interval data of the plurality of patterns. Therefore, according to the signal processing device 1A and the signal processing method S1A, the input/output interval data to be shared in the calculation of the output sample can be held for each pattern of the interval determined according to the combination of the first rate and the second rate. As a result, it is sufficient to select the input/output interval data for each calculation of the output sample instead of calculating the input/output interval data, and thus, it is possible to obtain an effect that the calculation amount is reduced.

### Third Exemplary Embodiment

A third exemplary embodiment that is an example of the example embodiments of the present invention will be described in detail with reference to the drawings. Components that have the same functions as the components described in the above-described exemplary embodiment are denoted by the same reference signs, and description of the components will be appropriately omitted. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technique illustrated in each of the drawings referred to for describing the present exemplary embodiment can be adopted in the other exemplary embodiments included in the present disclosure within a range in which no particular technical problem occurs.

### (Outline of Signal Processing Device 1B)

The signal processing device 1B according to the present exemplary embodiment is a modification of the signal processing device 1A according to the second exemplary embodiment. An outline of the idea of the inventor according to the aspect will be described.

The coefficient calculation processing by the coefficient calculation unit 12A in the signal processing device 1A according to the second exemplary embodiment described above includes multiplication by a multiplier that is not an integer power of 2 (hereinafter, also described as “non-power-of-two multiplication”). For example, multiplier 6 in Expression (3) is not an integer power of 2. For example, multiplier 2/3 in Expression (11) is not an integer power of 2. Here, multiplication (in the following description, it is also described as “power-of-two multiplication”) in which an integer power of 2 is a multiplier can be calculated by bit shifting, but a multiplier is required for non-power-of-two multiplication. Therefore, inclusion of non-power-of-two multiplication in the coefficient calculation processing repeatedly performed for each calculation of the output sample contributes to an increase in calculation amount. Therefore, the inventor has obtained an idea of reducing the non-power-of-two multiplication included in the coefficient calculation processing in order to reduce the calculation amount required for the sampling rate conversion. The signal processing device 1B is an aspect of the present invention based on the idea.

### (Configuration of Signal Processing Device 1B)

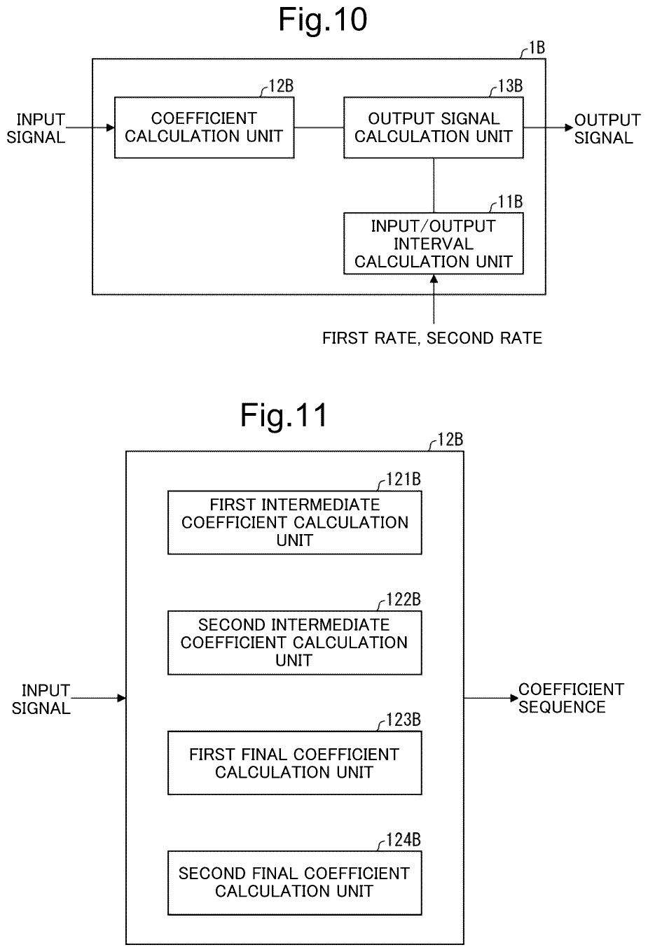

FIG. 10 is a block diagram illustrating a configuration of the signal processing device 1B. As illustrated in FIG. 10, the signal processing device 1B includes an input/output interval calculation unit 11B, a coefficient calculation unit 12B, and an output signal calculation unit 13B.

### (Input/Output Interval Calculation Unit 11B)

The input/output interval calculation unit 11B calculates data including a constant multiple of a value based on the interval between adjacent input samples and output samples as the input/output interval data. For example, the calculated “input/output interval data including a constant multiple” is held in a storage unit (not illustrated).

For example, in a high-order polynomial for calculating an output sample to be calculated, at least a part of a coefficient to be multiplied by a term of the input/output interval data can be corrected to a coefficient having a smaller number of times of non-power-of-two multiplication required to calculate the coefficient. The correction of the coefficient is achieved by multiplying the input/output interval data by a constant in the high-order polynomial. In other words, the constant is a number for reducing the number of times of multiplication other than the integral power of 2 in the coefficient calculation processing. More specifically, as the constant, a value is employed in which the number of non-power-of-two multiplications in the processing of calculating the coefficient sequence after correction is smaller than that in the processing of calculating the coefficient sequence before correction.

### (Coefficient Calculation Unit 12B)

FIG. 11 is a block diagram illustrating a detailed configuration of the coefficient calculation unit 12B. As shown in FIG. 11, the coefficient calculation unit 12B includes a first intermediate coefficient calculation unit 121B, a second intermediate coefficient calculation unit 122B, a first final coefficient calculation unit 123B, and a second final coefficient calculation unit 124B.

The first intermediate coefficient calculation unit 121B calculates a corrected first intermediate coefficient with reference to surrounding input samples. The corrected first intermediate coefficient is referred to for calculating a corrected second intermediate coefficient to be described later. The coefficient calculation processing by the first intermediate coefficient calculation unit 121B does not include non-power-of-two multiplication.

The second intermediate coefficient calculation unit 122B calculates the corrected second intermediate coefficient with reference to the corrected first intermediate coefficient. The corrected second intermediate coefficient is a coefficient referred to for obtaining the corrected first final coefficient. The coefficient calculation processing by the second intermediate coefficient calculation unit 122B includes non-power-of-two multiplication.

The first final coefficient calculation unit 123B calculates the corrected first final coefficient with reference to the corrected second intermediate coefficient. The coefficient calculation processing by the first final coefficient calculation unit 123B includes non-power-of-two multiplication.

The second final coefficient calculation unit 124B calculates the corrected second final coefficient with reference to the surrounding input samples and the corrected first final coefficient. The corrected second final coefficient is an example of the corrected coefficient described above. The coefficient calculation processing by the second final coefficient calculation unit 124B does not include non-power-of-two multiplication.

### (Output Signal Calculation Unit 13B)

The output signal calculation unit 13B calculates an output sample to be calculated using the “input/output interval data including a constant multiple” held in the storage unit and a coefficient sequence calculated according to the output sample to be calculated. The output signal calculation unit 13B may include a selection unit 131B and a calculation unit 132B (both not illustrated). The selection unit 131B and the calculation unit 132B will be similarly described by replacing “input/output interval data” with “input/output interval data including a constant multiple” in the description of the selection unit 131A and the calculation unit 132A, and thus, a detailed description thereof will not be repeated.

### Specific Example 1

Next, a first specific example of the input/output interval calculation unit 11B, the coefficient calculation unit 12B, and the output signal calculation unit 13B will be described. For example, each of the input/output interval calculation unit 11B, the coefficient calculation unit 12B, and the output signal calculation unit 13B may be configured by a calculation circuit exemplifying FPGA, ASIC, or the like.

### Specific Example 1 of Input/Output Interval Calculation Unit 11B

A first specific example of the input/output interval calculation processing by the input/output interval calculation unit 11B will be described.

For example, it is assumed that Expression (13) is an example of a high-order polynomial for calculating an output sample to be calculated.

For example, the coefficients b, c_k, and d in Expression (13) can be corrected to the corrected coefficients b′, c′_k, and d′. In order to reduce the number of times of non-power-of-two multiplication in the coefficient calculation processing of the corrected coefficients b′, c′_k, and d′, for example, “the square of the interval value” is multiplied by a constant “6” in the input/output interval data. Details of the reduction in the number of non-power-of-two multiplications will be described later.

In this case, the input/output interval calculation unit 11B calculates an interval value, 6 times the square of the interval value, and the cube of the interval value as “input/output interval data including a constant multiple”. The “input/output interval data including a constant multiple” is calculated for each of a plurality of patterns of intervals according to the first rate and the second rate.

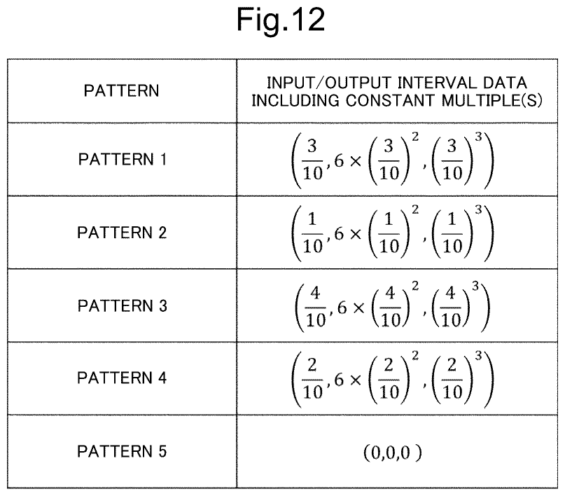

FIG. 12 is a diagram illustrating an example of “input/output interval data including a constant multiple” of a plurality of patterns in a case where the first rate is 2 and the second rate is 5/4. As illustrated in FIG. 12, the “input/output interval data including a constant multiple” of pattern 1 includes 3/10 which is an interval value, 6 times the square of 3/10, and the cube of 3/10. Similarly, the “input/output interval data including a constant multiple” of each of the patterns 2 to 4 includes an interval value (1/10, 4/10, or 2/10), 6 times the square of the interval value, and the cube of the interval value. Since the interval value of the “input/output interval data including a constant multiple” of the pattern 5 is 0, all of the interval value, six times the square of the interval value, and the cube of the interval value include 0.

### Specific Example 1 of Coefficient Calculation Unit 12B

A first specific example of coefficient calculation processing by the coefficient calculation unit 12B will be described. Here, an example in which the corrected coefficient c′_k described above is applied as the corrected first final coefficient will be described.

The first intermediate coefficient calculation unit 121B calculates the first intermediate coefficient α′_k by using, for example, the following Expressions (14) and (15).

$$\begin{matrix}[ Ex . 14 ] & \\ {a}_{k} = {y}_{k}^{i} ( k = 0 , 1 , … 2 D - 1 ) & ( 14 )\end{matrix}$$

$$\begin{matrix}[ Ex . 15 ] & \\ for k = 1 , 2 , … 2 D - 2 & \end{matrix}$$

$${{α}^{′}}_{k} = ( {a}_{k + 1} - 2 {a}_{k} + {a}_{k - 1} ) \qquad ( 15 )$$

Here, in the second exemplary embodiment, the Expressions (2) and (3) for calculating the first intermediate coefficient α_k include a multiplier “6” that is not an integer power of 2. On the other hand, Expressions (14) and (15) for calculating the corrected first intermediate coefficient α′_k do not include the non-power-of-two multiplication.

The second intermediate coefficient calculation unit 122B calculates the corrected second intermediate coefficients z′_k, μ_k, and 1_k, for example, using the following Expressions (16) to (19).

$$\begin{matrix}[ Ex . 16 ] & \\ {l}_{0} = {l}_{2 D - 1} = 1 & ( 16 )\end{matrix}$$

$$\begin{matrix}[ Ex . 17 ] & \\ {μ}_{0} = {μ}_{2 D - 1} = 0 & ( 17 )\end{matrix}$$

$$\begin{matrix}[ Ex . 18 ] & \\ {z}_{0}^{{′}^{}} = {z}_{2 D - 1}^{{′}^{}} = 0 & ( 18 )\end{matrix}$$

$$\begin{matrix}[ Ex . 19 ] & \\ for k = 1 , 2 , … 2 D - 2 & \end{matrix}$$

$${l}_{k} = 2 - \frac{1}{2} {μ}_{k - 1} , {μ}_{k} = \frac{1}{2 {l}_{k}} , {z}_{k}^{{′}^{}} = ( {α}_{k}^{′} - 0.5 {z}_{k - 1}^{{′}^{}} ) / {l}_{k} \qquad ( 19 )$$

Expressions (16) to (19) for calculating the corrected second intermediate coefficients z′_k, μ_k, and 1_k are similar to Expressions (4) to (7) for calculating the second intermediate coefficients z_k, μ_k, and 1_k in the second exemplary embodiment except that the corrected first intermediate coefficient α′_k is referred to. For this reason, Expressions (16) to (19) include the non-power-of-two multiplication similarly to Expressions (4) to (7).

The first final coefficient calculation unit 123B calculates the corrected first final coefficient c′_k by using, for example, the following Expressions (20) and (21).

$$\begin{matrix}[ Ex . 20 ] & \\ {c}_{2 D - 1}^{{′}^{}} = 0 & ( 20 )\end{matrix}$$

$$\begin{matrix}[ Ex . 21 ] & \\ for k = 2 D - 2 , 2 D - 1 , … D - 1 & \end{matrix}$$

$${c}_{k}^{′} = {z}_{k}^{′} - {μ}_{k} {c}_{k + 1}^{′} \qquad ( 21 )$$

Expressions (20) and (21) for calculating the corrected first final coefficient c′_k are similar to Expressions (8) and (9) for calculating the first final coefficient c_k in the second exemplary embodiment except that the corrected second intermediate coefficient z′_k is referred to. For this reason, Expressions (20) and (21) include multiplication that is non-power-of two similarly to Expressions (8) and (9).

The second final coefficient calculation unit 124B calculates the corrected second final coefficients b′ and d′ using, for example, the following Expressions (22) and (23).

$$\begin{matrix}[ Ex . 22 ] & \\ {b}^{′} = 2 ( {a}_{D} - {a}_{D - 1} ) - ( {c}_{D}^{′} + 2 {c}_{D - 1}^{′} ) & ( 22 )\end{matrix}$$

$$\begin{matrix}[ Ex . 23 ] & \\ {d}^{′} = 4 ( {c}_{D}^{′} + 2 {c}_{D - 1}^{′} ) & ( 23 )\end{matrix}$$

Here, in the second exemplary embodiment, the Expressions (10) and (11) for calculating the second final coefficients b and d include multipliers “1/6” and “2/3” that are not integral powers of 2. In contrast, Expressions (22), (23) for calculating the corrected second final coefficients b′ and d′ do not include a non-power-of-two multiplication.

### Specific Example 1 of Output Signal Calculation Unit 13B

A first specific example of the output signal calculation processing by the output signal calculation unit 13B will be described. For example, the output signal calculation unit 13B calculates the value y\hat{ }o of the output sample to be calculated using the following Expression (24) which is a high-order polynomial. In Expression (24), the coefficients b′, c′_k, and d′ calculated according to the output sample and “input/output interval data including a constant multiple” (interval value, six times square of interval value, and cube of interval value) of the pattern held in the storage unit are referred to. For example, among the “input interval data including a constant multiple” of the five patterns illustrated in FIG. 12, data according to a pattern associated with the interval between the output sample (x\hat{ }o, y\hat{ }o) and the immediately preceding input sample is referred to.

$$\begin{matrix}[ Ex . 24 ] & \\ {y}^{o} = {a}_{D - 1} + {b}^{′} ( {x}^{o} - {x}_{D - 1}^{i} ) + {c}_{D - 1}^{′} 6 {( {x}^{o} - {x}_{D - 1}^{i} )}^{2} + {{d}^{′} ( {x}^{o} - {x}_{D - 1}^{i} )}^{3} & ( 24 )\end{matrix}$$

### Specific Example 2

Next, a second specific example of the input/output interval calculation unit 11B, the coefficient calculation unit 12B, and the output signal calculation unit 13B will be described. For example, similarly to specific example 1, each of the input/output interval calculation unit 11B, the coefficient calculation unit 12B, and the output signal calculation unit 13B may be configured by a calculation circuit using FPGA, ASIC, or the like as an example.

### Specific Example 2 of Input/Output Interval Calculation Unit 11B

A second specific example of the input/output interval calculation processing by the input/output interval calculation unit 11B will be described.

In the specific example, the corrected coefficients b′ and c′_k similar to those in the first specific example are used, and the corrected coefficient d″ different from that in the first specific example is used. In order to reduce the number of times of non-power-of-two multiplication in the coefficient calculation processing of the corrected coefficient d″, in addition to multiplying the square of the interval value by the constant “6” as in specific example 1, the cube of the interval value is multiplied by the constant “4”. As a result, in the coefficient calculation processing, the number of times of multiplication for each output sample in the second final coefficient calculation unit 124B further decreases from specific example 1. Details will be described later.

In this case, the input/output interval calculation unit 11B calculates an interval value, 6 times the square of the interval value, and 4 times the cube of the interval value as “input/output interval data including a constant multiple”. The “input/output interval data including a constant multiple” is calculated for each of a plurality of patterns of intervals according to the first rate and the second rate.

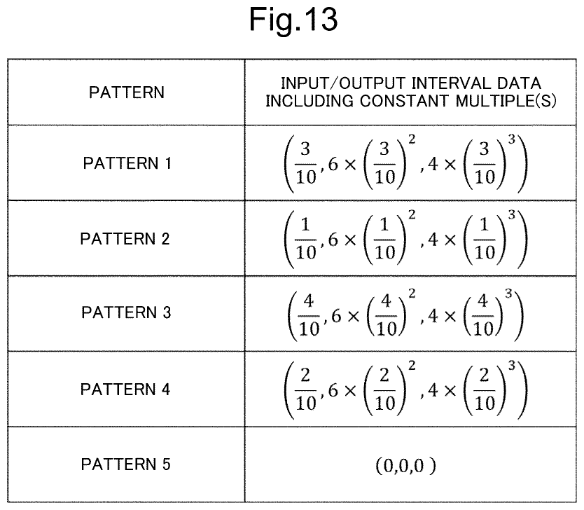

FIG. 13 is a diagram illustrating an example of “input/output interval data including a constant multiple” in a case where the first rate is 2 and the second rate is 5/4. As illustrated in FIG. 13, “input/output interval data including a constant multiple” of pattern 1 includes 3/10 which is an interval value, 6 times the square of 3/10, and 4 times the cube of 3/10. Similarly, the “input/output interval data including a constant multiple” of each of the patterns 2 to 4 includes an interval value (1/10, 4/10, or 2/10), 6 times the square of the interval value, and 4 times the cube of the interval value. Since the interval value is 0, the “input/output interval data including a constant multiple” of the pattern 5 includes 0 as the interval value, six times the square of the interval value, and four times the cube of the interval value.

### Specific Example 2 of Coefficient Calculation Unit 12B

A second specific example of coefficient calculation processing by the coefficient calculation unit 12B will be described. Calculation of b′ among the corrected first intermediate coefficient α′_k, the corrected second intermediate coefficients z′_k, μ_k, and 1_k, the corrected first final coefficient c′ k, and the corrected second final coefficient will be described in the same manner as in specific example 1, and thus detailed description will not be repeated.

The second final coefficient calculation unit 124B calculates the second final coefficient d″ after correction using, for example, the following Expression (25).

$$\begin{matrix}[ Ex . 25 ] & \\ {d}^{″} = ( {c}_{D}^{′} - {c}_{D - 1}^{′} ) & ( 25 )\end{matrix}$$

Also in specific example 1, Expression (23) for calculating the second final coefficient d′ after correction did not include the non-power-of-two multiplication but included the power-of-two multiplication. On the other hand, in the present specific example, Expression (25) for calculating the corrected second final coefficient d″ does not include the multiplication itself.

### Specific Example 2 of Output Signal Calculation Unit 13B

A second specific example of the output signal calculation processing by the output signal calculation unit 13B will be described. The present specific example is different in that the following Expression (26) is used instead of Expression (24) in specific example 1 in order to calculate the value y\hat{ }o of the output sample to be calculated. In Expression (26), the coefficients b′, c′_k, and d″ calculated according to the output sample and “input/output interval data including a constant multiple” (the interval value, six times the square of the interval value, and four times the cube of the interval value) of the pattern held in the storage unit are referred to. For example, among the “input/output interval data including a constant multiple” of the five patterns illustrated in FIG. 13, data according to a pattern associated with the interval between the output sample (x\hat{ }o, y\hat{ }o) and the immediately preceding input sample is referred to.

$$\begin{matrix}[ Ex . 26 ] & \\ {y}^{o} = {a}_{D - 1} + {b}^{′} ( {x}^{o} - {x}_{D - 1}^{i} ) + {c}_{D - 1}^{′} 6 {( {x}^{o} - {x}_{D - 1}^{i} )}^{2} + {d}^{″} 4 {( {x}^{o} - {x}_{D - 1}^{i} )}^{3} & ( 26 )\end{matrix}$$

### (Flow of Signal Processing Method S1B)

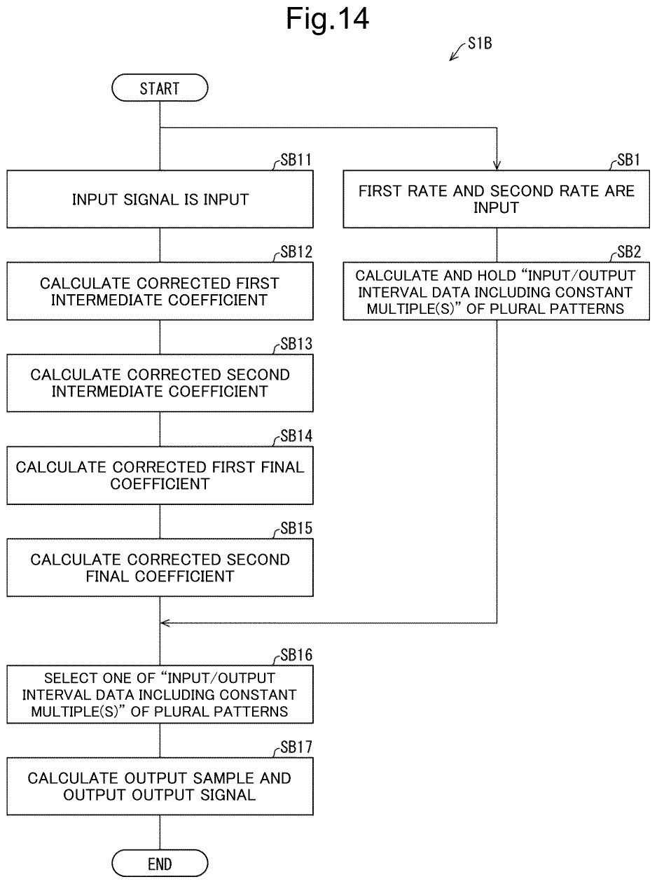

FIG. 14 is a flowchart illustrating a flow of the signal processing method S1B executed by the signal processing device 1B. As illustrated in FIG. 14, the signal processing method S1B includes steps SB1 to SB2 and SB11 to SB17. Steps SB1 to SB2 may be executed at least once. Steps SB11 to SB17 are repeatedly executed for each calculation of the output sample.

Step SB1 is described similarly to step SA1, and thus, a detailed description thereof will not be repeated. In step SB2, the input/output interval calculation unit 11B calculates “input/output interval data including a constant multiple” of a plurality of patterns based on the first rate and the second rate. The calculated “input/output interval data including a constant multiple” is held in the storage unit. As a result, it is not necessary to perform the processing of steps SB1 to SB2 for each calculation of the output sample, whereby the calculation amount is reduced.

Step SB11 is described similarly to step SA11, and thus, a detailed description thereof will not be repeated.

In step SB12, the first intermediate coefficient calculation unit 121B calculates the corrected first intermediate coefficient with reference to the surrounding input samples, and inputs the corrected first intermediate coefficient to the second intermediate coefficient calculation unit 122B. For example, in order to calculate the corrected first intermediate coefficient, the above-described Expressions (14) and (15) may be used, but the present invention is not limited thereto. The processing of this step does not include non-power-of-two multiplication.

In step SB13, the second intermediate coefficient calculation unit 122B refers to the corrected first intermediate coefficient to calculate the corrected second intermediate coefficient, and inputs the corrected second intermediate coefficient to the first final coefficient calculation unit 123B. For example, in order to calculate the corrected second intermediate coefficient, the above-described Expressions (16) to (19) may be used, but the present invention is not limited thereto.

In step SB14, the first final coefficient calculation unit 123B calculates the corrected first final coefficient with reference to the corrected second intermediate coefficient, and inputs the corrected first final coefficient to the second final coefficient calculation unit 124B and the output signal calculation unit 13B. For example, the above-described Expressions (20) and (21) may be used to calculate the corrected first final coefficient, but the present invention is not limited thereto.

In step SB15, the second final coefficient calculation unit 124B calculates the corrected second final coefficient with reference to the surrounding input samples and the corrected first final coefficient, and inputs the corrected second final coefficient to the output signal calculation unit 13B. For example, the above-described Expressions (22) and (23) (or Expressions (22) and (25)) may be used to calculate the corrected second final coefficient, but the present invention is not limited thereto. The processing of this step does not include non-power-of-two multiplication.

In step SB16, the selection unit 131B selects data of a pattern associated with the output sample to be calculated from among the “input/output interval data including a constant multiple” of the plurality of patterns held in the storage unit.

In step SB17, the calculation unit 132B calculates and outputs an output sample using the surrounding input samples, the selected “input/output interval data including a constant multiple”, the corrected first final coefficient, and the corrected second final coefficient. For example, Expression (24) (or Expression (26)) described above may be used to calculate the output sample, but is not limited thereto.

Steps SB11 to SB17 are repeated to calculate the next output sample to be calculated. As a result, output samples are sequentially output to configure an output signal.

### Effects of Present Exemplary Embodiment

As described above, in the signal processing device 1B and the signal processing method S1B, the input/output interval calculation processing by the input/output interval calculation unit 11B calculates, as the input/output interval data, data including a constant multiple of a value based on the interval between adjacent input samples and output samples, and the constant is a number that makes the number of times of multiplication other than an integer power of 2 smaller in the coefficient calculation processing by the coefficient calculation unit 12B. Therefore, according to the signal processing device 1B and the signal processing method S1B, it is possible to reduce the calculation amount for calculating the coefficient sequence while accurately performing the processing of converting the sample rate of the signal in the communication system by interpolation of the curve. The number of multipliers for performing multiplication other than the integral power of 2 can be reduced, and the circuit scale can be reduced.

### Fourth Exemplary Embodiment

A fourth exemplary embodiment that is an example of an example embodiment of the present invention will be described in detail with reference to the drawings. Components that have the same functions as the components described in the above-described exemplary embodiment are denoted by the same reference signs, and description of the components will be appropriately omitted. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technique illustrated in each of the drawings referred to for describing the present exemplary embodiment can be adopted in the other exemplary embodiments included in the present disclosure within a range in which no particular technical problem occurs.

### (Outline of Signal Processing Device 1C)

The signal processing device 1C according to the present exemplary embodiment is an aspect modified to branch the output signal calculation processing in the signal processing device 1A according to the second exemplary embodiment.

### (Configuration of Signal Processing Device 1C)

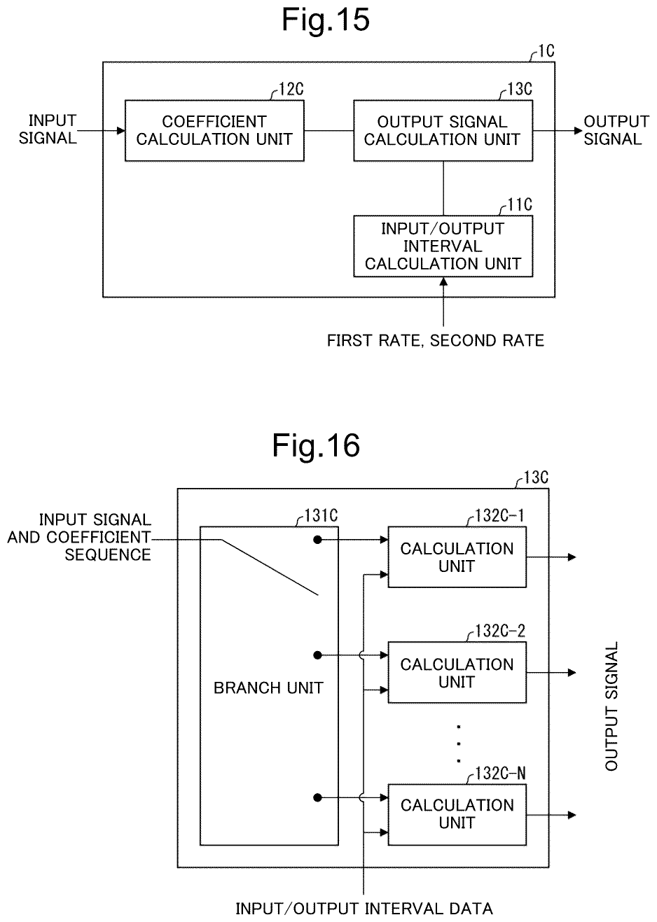

FIG. 15 is a block diagram illustrating a configuration of the signal processing device 1C. As illustrated in FIG. 15, the signal processing device 1C includes an input/output interval calculation unit 11C, a coefficient calculation unit 12C, and an output signal calculation unit 13C. Since the input/output interval calculation unit 11C and the coefficient calculation unit 12C are configured similarly to the input/output interval calculation unit 11A and the coefficient calculation unit 12A in the second exemplary embodiment, a detailed description thereof will not be repeated. In the present exemplary embodiment, the number of patterns of the input/output interval data calculated by the input/output interval calculation unit 11C is N (N is an integer of 2 or more). In other words, the input/output interval calculation unit 11C calculates the input/output interval data for each of the intervals of the N patterns.

### (Output Signal Calculation Unit 13C)

FIG. 16 is a block diagram illustrating a detailed configuration of the output signal calculation unit 13C. As illustrated in FIG. 16, the output signal calculation unit 13C includes a branch unit 131C and N calculation units 132C-i (i=1, 2, . . . , N).

The branch unit 131C inputs a coefficient sequence and an input signal associated with an output sample to be calculated to any one of the calculation units 132C-i associated with the N patterns. Here, the calculation unit 132C-i as the input destination of the coefficient sequence and the input signal is selected according to the pattern indicated by the output sample to be calculated and the interval of the input sample immediately before (or immediately after) the output sample.

The calculation unit 132C-i calculates an output sample to be calculated using the input/output interval data of the i-th pattern among the N patterns, and the coefficient sequence and the input signal input from the branch unit 131C.

### Specific Example of Output Signal Calculation Unit 13C

A specific example of the output signal calculation processing by the output signal calculation unit 13C will be described. Here, for example, the output signal calculation unit 13C may be configured by a calculation circuit using FPGA, ASIC, or the like as an example. In the present specific example, as an example, the first rate is 2, and the second rate is 5/4. As an example, “an interval between an output sample and an input sample immediately before the output sample” is applied as an interval between adjacent input samples and output samples. In this case, N=5, and the output signal calculation unit 13C includes calculation units 132C-1 to 131C-5. The calculation units 132C-1 to 132C-5 perform calculation using each of the five types of input/output interval data illustrated in FIG. 8.

Specifically, for example, the calculation unit 132C-1 calculates the output sample to be calculated using the following Expression (27).

$$\begin{matrix}[ Ex . 27 ] & \\ {y}^{o} = {a}_{D - 1} + \frac{3}{10} b + {( \frac{3}{10} )}^{2} {c}_{D - 1} + {( \frac{3}{10} )}^{3} d & ( 27 )\end{matrix}$$

The calculation unit 132C-2 calculates the output sample to be calculated using an expression in which “3/10” in Expression (27) is replaced with “1/10”. The calculation unit 132C-3 calculates the output sample to be calculated using an expression in which “3/10” in Expression (27) is replaced with “4/10”. The calculation unit 132C-4 calculates the output sample to be calculated using an expression in which “3/10” in Expression (27) is replaced with “2/10”.

The calculation unit 132C-5 calculates the output sample to be calculated using an expression in which “3/10” in Expression (27) is replaced with “0”. Alternatively, the calculation unit 132C-5 can be configured to omit the calculation and output a_D-1 as it is. As a result, the calculation amount of the output sample associated with the pattern 5 can be reduced.

### (Flow of Signal Processing Method SIC)

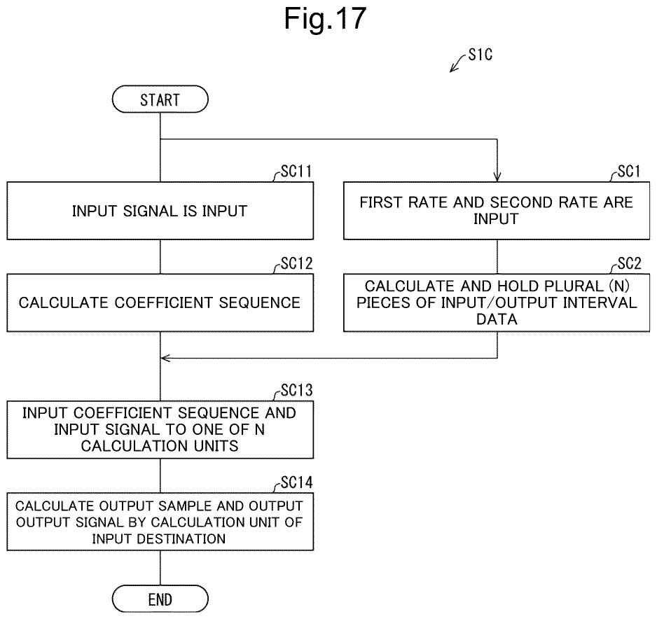

FIG. 17 is a flowchart illustrating a flow of the signal processing method SIC executed by the signal processing device 1C. As illustrated in FIG. 17, the signal processing method S1C includes steps SC1 to SC2 and SC11 to SC14. Steps SC1 and SC2 may be executed at least once. Steps SC11 to SC14 are repeatedly executed for each calculation of the output sample.

Steps SC1 to SC2 and SC11 are described similarly to steps SA1 to SA2 and SA11, and thus, a detailed description thereof will not be repeated.

In step SC12, the coefficient calculation unit 12C calculates a coefficient related to the interval value and a coefficient related to the power of the interval value as a coefficient sequence associated with the output sample to be calculated. For example, the coefficient calculation unit 12C may calculate the first intermediate coefficient, the second intermediate coefficient, the first final coefficient, and the second final coefficient as in steps SA12 to SA15.

In step SC13, the branch unit 131C performs branch processing of inputting a coefficient sequence and an input signal to any one of the N calculation units 132C-i. The calculation unit 132C-i of the input destination is selected according to a pattern indicated by an interval between an output sample to be calculated and an input sample immediately before (or immediately after) the output sample.

In step SC14, the calculation unit 132C-i selected by the branch processing calculates and outputs an output sample to be calculated using the input coefficient sequence and the input signal.

Steps SC11 to SC14 are repeated to calculate the next output sample to be calculated. As a result, output samples are sequentially output to configure an output signal.

### Effects of Present Exemplary Embodiment

As described above, in the signal processing device 1C and the signal processing method S1C, the configuration is adopted in which the input/output interval calculation processing by the input/output interval calculation unit 11C calculates the input/output interval data for each of the N patterns, and the output signal calculation processing by the output signal calculation unit 13C includes the branch unit 131C that inputs the coefficient sequence according to the output sample to be calculated to any of the calculation units 132C-i associated with each of the N patterns, and the calculation unit 132C-i that is each of the N calculation units 132C-i and calculates the output sample to be calculated using the input/output interval data of the associated pattern and the coefficient sequence input by the branch unit 131C. Thus, according to the signal processing device 1C and the signal processing method SIC, the calculation unit 132C-i is configured to exist associated with each pattern of the input/output interval data. As a result, there is an effect that each of the calculation units 132C-i that calculate the output samples can be optimized and simply implemented according to the associated input/output interval data.

The signal processing device 1C according to the present exemplary embodiment may be achieved by modifying the signal processing device 1B according to the third exemplary embodiment instead of modifying the signal processing device 1A according to the second exemplary embodiment. For example, the coefficient calculation unit 12C may be configured similarly to the coefficient calculation unit 12B.

### Fifth Exemplary Embodiment

A fifth exemplary embodiment which is an example of the example embodiments of the present invention will be described in detail with reference to the drawings. Components that have the same functions as the components described in the above-described exemplary embodiment are denoted by the same reference signs, and description of the components will be appropriately omitted. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technique illustrated in each of the drawings referred to for describing the present exemplary embodiment can be adopted in the other exemplary embodiments included in the present disclosure within a range in which no particular technical problem occurs.

### (Outline of Signal Processing Device 1D)

The signal processing device 1D according to the present exemplary embodiment is a modified aspect in which a plurality of input signals are processed in parallel in the signal processing device 1A according to the second exemplary embodiment.

### (Configuration of Signal Processing Device 1D)

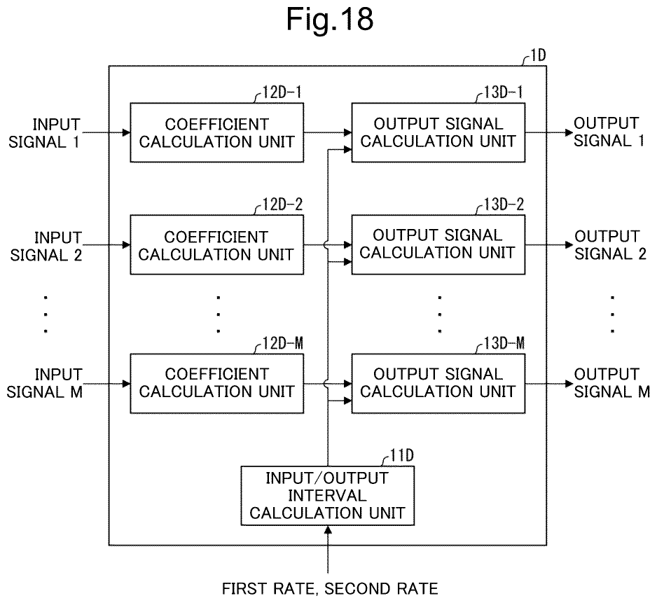

FIG. 18 is a block diagram illustrating a configuration of the signal processing device 1D. As illustrated in FIG. 18, the signal processing device 1D is a circuit that converts the sampling rate of each of the plurality of input signals i (i=1, 2, . . . , M: M is an integer of 2 or more) input in parallel from the first rate to the second rate and outputs the plurality of output signals i in parallel. The sampling rate of the input signal i is the first rate, and the sampling rate of the output signal i is the second rate. The signal processing device 1D includes an input/output interval calculation unit 11D, M coefficient calculation units 12D-i, and M output signal calculation units 13D-i. The input/output interval calculation unit 11D, the coefficient calculation unit 12D-i, and the output signal calculation unit 13D-i are configured similarly to the input/output interval calculation unit 11A, the coefficient calculation unit 12A, and the output signal calculation unit 13A in the second exemplary embodiment, and thus, a detailed description thereof will not be repeated.

### (Flow of Signal Processing Method SID)

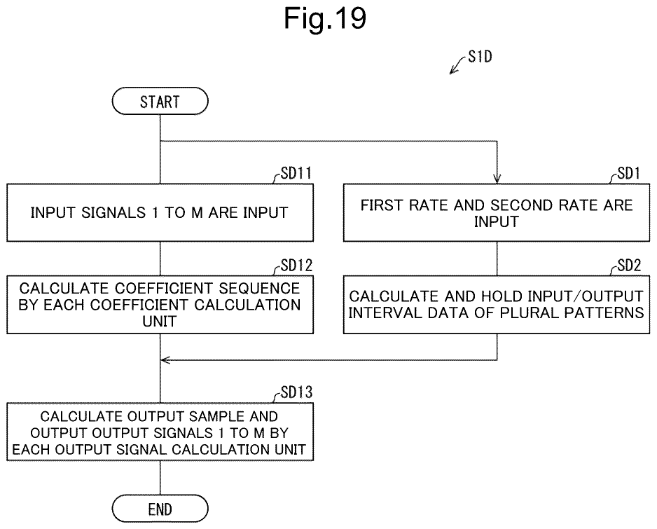

FIG. 19 is a flowchart illustrating a flow of the signal processing method SID executed by the signal processing device 1D. As illustrated in FIG. 19, the signal processing method SID includes steps SD1, SD2 and SD11 to SD13. Steps SD1 and SD2 may be executed at least once. Steps SD11 to SD13 are repeatedly executed for each calculation of the output sample in the output signal i associated with the input signal i.

In steps SD1 and SD2, the input/output interval calculation unit 11D executes the input/output interval calculation processing similarly to steps SA1 and SA2. The input/output interval calculation processing is executed in common for a plurality of combinations of the input signal i and the output signal i.

In step SD11, each of the plurality of input signals i is input to the associated coefficient calculation unit 12D-i.

In step SD12, each coefficient calculation unit 12D-i calculates a coefficient related to the interval value and a coefficient related to the power of the interval value as a coefficient sequence associated with the calculation target output sample in the associated output signal i. For example, each coefficient calculation unit 12D-i may calculate the first intermediate coefficient, the second intermediate coefficient, the first final coefficient, and the second final coefficient as in steps SA12 to SA15. The coefficient calculation unit 12D-i inputs the calculated coefficient sequence to the associated output signal calculation unit 13D-i. In other words, the coefficient calculation processing by each coefficient calculation unit 12D-i is executed in parallel for each of the plurality of combinations of the input signal i and the output signal i.

In step SD13, each output signal calculation unit 13D-i calculates and outputs an output sample to be calculated in the output signal i by using the surrounding input sample in the input signal i, the input coefficient sequence, and any input/output interval data of a plurality of patterns calculated in common. In other words, the output signal calculation processing by each output signal calculation unit 13D-i is executed in parallel for each of a plurality of combinations of the input signal i and the output signal i.

Steps SD11 to SD13 are repeated in order to calculate the next to-be-calculated output sample in each output signal i. As a result, output samples are sequentially output from each output signal calculation unit 13D-i to configure an output signal i.

### Effects of Present Exemplary Embodiment

As described above, in the signal processing device 1D and the signal processing method SID, in the signal processing device 1D and the signal processing method SID that convert the sampling rate of each of the plurality of input signals i input in parallel from the first rate to the second rate and output the plurality of output signals i in parallel, the input/output interval calculation processing by the input/output interval calculation unit 11D is executed in common for the plurality of combinations of the input signal i and the output signal i, and the calculation processing by the coefficient calculation unit 12D-i and the output signal calculation processing by the output signal calculation unit 13D-i are executed in parallel for each of the plurality of combinations of the input signal i and the output signal i. Thus, according to the signal processing device 1D and the signal processing method SID, the input/output interval data of the plurality of patterns is calculated and held in advance as common data for the plurality of input signals i. As a result, the calculation amount required for the sampling rate conversion of the plurality of input signals i input in parallel can be reduced. A signal holding amount required for the sampling rate conversion of the plurality of input signals i input in parallel can be reduced.

The signal processing device 1D according to the present exemplary embodiment may be achieved by modifying the signal processing device 1B according to the third exemplary embodiment instead of modifying the signal processing device 1A according to the second exemplary embodiment. For example, the coefficient calculation unit 12D-i may be configured similarly to the coefficient calculation unit 12B.

### Sixth Exemplary Embodiment

A sixth exemplary embodiment which is an example of the example embodiments of the present invention will be described in detail with reference to the drawings. Components that have the same functions as the components described in the above-described exemplary embodiment are denoted by the same reference signs, and description of the components will be appropriately omitted. An application range of each technology adopted in the present exemplary embodiment is not limited to the present exemplary embodiment. In other words, each technology adopted in the present exemplary embodiment can also be adopted in another exemplary embodiment included in the present disclosure within a range in which no particular technical problem occurs. Each technique illustrated in each of the drawings referred to for describing the present exemplary embodiment can be adopted in the other exemplary embodiments included in the present disclosure within a range in which no particular technical problem occurs.

### (Outline of Signal Processing Device 1E)

The signal processing device 1E according to the present exemplary embodiment is a modified aspect in which the signal processing device 1A according to the second exemplary embodiment directly outputs an input sample that does not require coefficient calculation as an output sample.

### (Configuration of Signal Processing Device 1E)

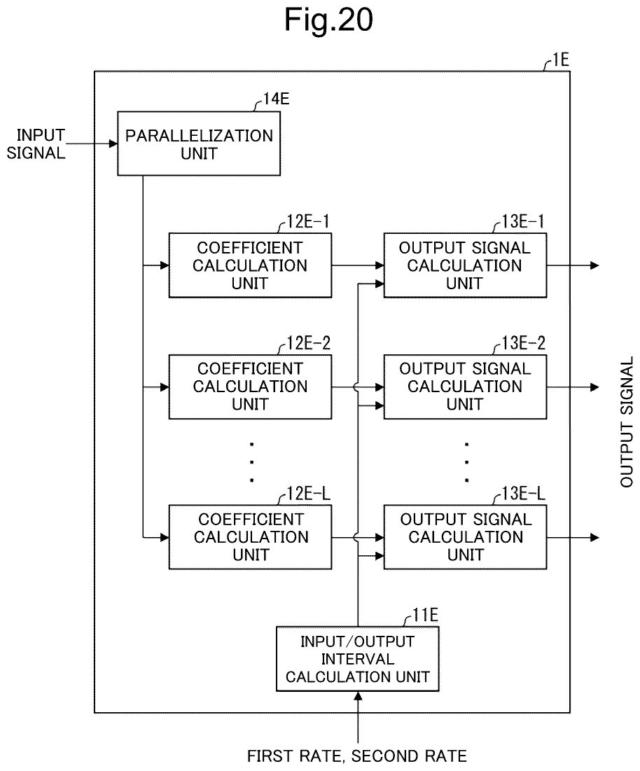

FIG. 20 is a block diagram illustrating a configuration of the signal processing device 1E. As illustrated in FIG. 20, the signal processing device 1E includes an input/output interval calculation unit 11E, a plurality of coefficient calculation units 12E-i (i=1, 2, . . . , L), a plurality of output signal calculation units 13E-i, and a parallelization unit 14E. Here, Lis an integer of 2 or more, which is one less than the number of patterns of the interval with the adjacent input sample.

The parallelization unit 14E parallelizes the input signal into a plurality of parallel channels. At least one first parallel channel of the plurality of parallel channels is configured by an input sample whose interval with the output sample is zero. The input samples included in the first parallel channel are output as output samples.

Here, the interval between adjacent inputs and outputs samples periodically becomes zero. In other words, any one of the plurality of patterns of intervals of the adjacent input and output samples has zero interval. For the output sample whose interval becomes zero, the output signal calculation processing using the input/output interval data and the coefficient sequence is unnecessary. Therefore, the calculation amount can be reduced by parallelizing the input signal in such a way as to include the first parallel channel including the input sample that does not require calculation.

However, the input sample whose interval with the output sample is zero can be output as it is as the output sample without requiring calculation, and it is necessary to refer to the input sample at the time of calculation in order to calculate another output sample different from the output sample that does not require calculation. Therefore, the parallelization unit 14E performs parallelization by overlapping the input samples in such a way that the input sample whose interval with the output sample becomes 0 is also included in another parallel channel different from the first parallel channel. As a result, the number of parallel channels is one more than the period of the input sample at which the interval with the output sample is zero. Since the cycle of the input sample is determined according to the combination of the first rate and the second rate, the number of parallel channels is also determined according to the combination of the first rate and the second rate. For example, in a case where the first rate is twice and the second rate is 9/8 times, the period of the input sample at which the interval with the output sample is 0 is 16, and thus the number of parallel channels is 17.

The coefficient calculation unit 12E-i calculates a coefficient sequence based on surrounding input samples included in at least a part of the plurality of parallel channels, with an output sample whose interval with an adjacent input sample is other than 0 as a calculation target. For example, the coefficient calculation processing by the plurality of coefficient calculation units 12E-i may be executed in parallel.

The output signal calculation unit 13E-i calculates the output sample to be calculated using the input/output interval data and the coefficient sequence. For example, the coefficient calculation processing by the plurality of output signal calculation units 13E-i may be executed in parallel.

An output signal is configured by the output samples calculated by the plurality of output signal calculation units 13E-i and the output samples from which the first parallel channel is output as it is.

### Specific Example of Signal Processing Device 1E

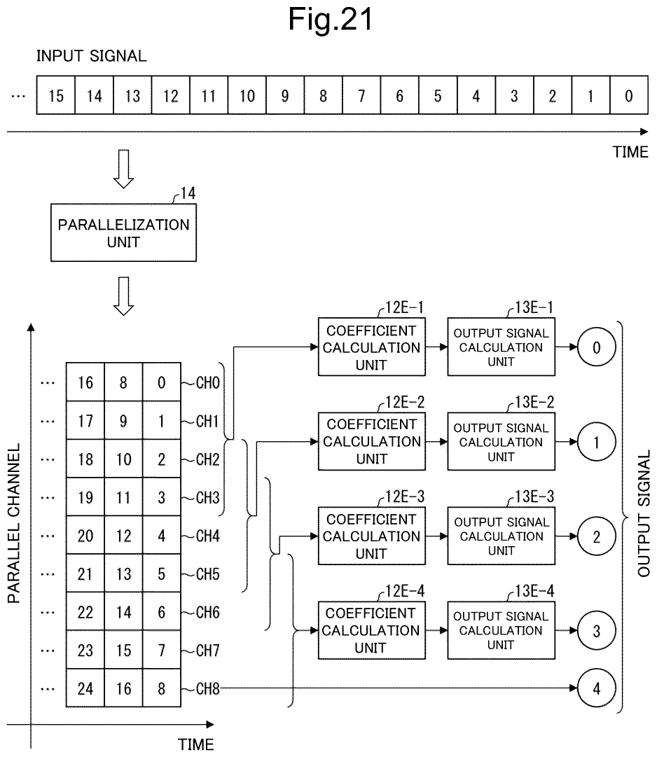

FIG. 21 is a schematic diagram illustrating a specific example of the signal processing device 1E. Here, for example, each unit configuring the signal processing device 1E may be configured by a calculation circuit using an FPGA, an ASIC, or the like as an example. In the present specific example, as an example, the first rate is 2, and the second rate is 5/4. As an example, “an interval between an output sample and an input sample immediately before the output sample” is applied as an interval between adjacent input samples and output samples. In this case, as described above, the intervals are five patterns of 3/10, 1/10, 4/10, 2/10, and 0. These patterns are referred to as patterns 1 to 5 as illustrated in FIG. 8, for example. The number of patterns having intervals other than 0 is four of the patterns 1 to 4, and the number L of the coefficient calculation units 12E-i and the output signal calculation units 13E-i is four.

In FIG. 21, input samples included in an input signal are input to the signal processing device 1E temporally continuously. A rectangle surrounding the numerical value n indicates the n-th input sample n.

The j-th output sample j configuring the output signal is output from the signal processing device 1E. A circle surrounding the numerical value j indicates the output sample j.

In this specific example, the input sample whose interval with the output sample is zero appears every eight sampling time points. For example, the input samples 0, 8, 16, . . . have 0 intervals from the output samples to be output. Therefore, the parallelization unit 14E parallelizes the input samples one by one into nine parallel channels CH0 to CH8. Specifically, the parallelization unit 14E parallelizes the nine input samples 0 to 8 to the parallel channels CH0 to CH8. Next, the parallelization unit 14E parallelizes the nine input samples 8 to 16 to the parallel channels CH0 to CH8. Next, the parallelization unit 14E parallelizes the nine input samples 16 to 24 to the parallel channels CH0 to CH8. In this manner, the parallelization unit 14E sequentially parallelizes the input samples. As a result, the parallel channel CH0 includes input samples 0, 8, 16, . . . . The parallel channel CH1 includes input samples 1, 9, 17, . . . . The parallel channel CH2 includes input samples 2, 10, 18, . . . . The parallel channel CH3 includes input samples 3, 11, 19, . . . . The parallel channel CH4 includes input samples 4, 12, 20, . . . . The parallel channel CH5 includes input samples 5, 13, 21, . . . . The parallel channel CH6 includes input samples 6, 14, 22, . . . . The parallel channel CH7 includes input samples 7, 15, 23, . . . . The parallel channel CH8 includes input samples 8, 16, 24. . . .

In this specific example, it is assumed that D=2. That is, two input samples before and after the output sample j to be calculated are referred to as samples around the output sample 0.

In this case, four input samples of the parallel channels CH0 to CH3 are input to the coefficient calculation unit 12E-1 as surrounding input samples. The coefficient sequence calculated by the coefficient calculation unit 12E-1 is input to the output signal calculation unit 13E-1. The output signal calculation unit 13E-1 calculates and outputs an output sample 0 using the coefficient sequence, the surrounding input samples, and the input/output interval data of the pattern 1 held in the storage unit.

Four input samples of the parallel channels CH2 to C5 are input to the coefficient calculation unit 12E-2 as surrounding input samples. The coefficient sequence calculated by the coefficient calculation unit 12E-2 is input to the output signal calculation unit 13E-2. From the output signal calculation unit 13E-2 the output sample 1 is calculated and output using the coefficient sequence, the surrounding input samples, and the input/output interval data of the pattern 2 held in the storage unit.

Four input samples of the parallel channels CH3 to C6 are input to the coefficient calculation unit 12E-3 as surrounding input samples. The coefficient sequence calculated by the coefficient calculation unit 12E-3 is input to the output signal calculation unit 13E-3. From the output signal calculation unit 13E-3 the output sample 2 is calculated and output using the coefficient sequence, the surrounding input samples, and the input/output interval data of the pattern 3 held in the storage unit.

Four input samples of the parallel channels CH5 to C8 are input to the coefficient calculation unit 12E-4 as surrounding input samples. The coefficient sequence calculated by the coefficient calculation unit 12E-4 is input to the output signal calculation unit 13E-4. From the output signal calculation unit 13E-4 the output sample 3 is calculated and output using the coefficient sequence, the surrounding input samples, and the input/output interval data of the pattern 4 held in the storage unit.

Here, the parallel channel CH8 is an example of a first parallel channel including the input samples 8, 16, and 24 whose intervals with the output samples are 0. The parallel channel CH8 is directly output as the output sample 4.

Similarly, output samples 5 to 9, 10 to 14, . . . are sequentially calculated and output as output signals.

This specific example will be similarly described by appropriately adjusting the number of parallel channels and the number of coefficient calculation units 12E-i and output signal calculation units 13E-i even in a case where one or both of the first rate and the second rate are different. The present specific example has been described assuming that D=2, but the range to be referred to as a surrounding input sample is not limited to two points each before and after. In that case, the same description will be given by appropriately adjusting the parallel channel input to each coefficient calculation unit 12E-i.

### (Flow of Signal Processing Method S1E)

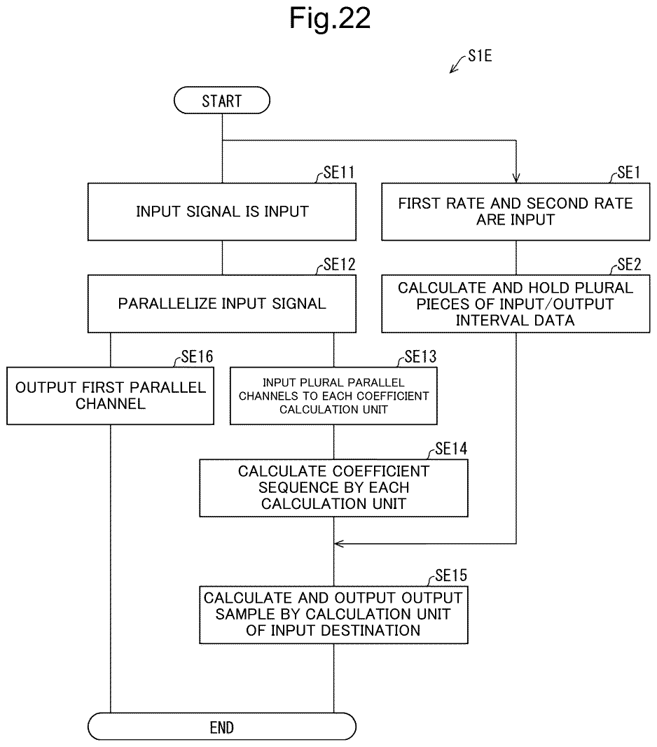

FIG. 22 is a flowchart illustrating a flow of the signal processing method SIE executed by the signal processing device 1E. As shown in FIG. 22, the signal processing method S1E includes steps SE1, SE2 and SE11 to SE16. Steps SE1 and SE2 need only be executed at least once. Steps SE11 to SE16 are repeatedly executed for each calculation of an output sample of each parallel channel.

Steps SE1 and SE2 are described similarly to steps SA1 and SA2, and thus, detailed description thereof will not be repeated.

In step SE11, an input signal is input to the parallelization unit 14E.

In step SE12, the parallelization unit 14E parallelizes the input signal into a plurality of parallel channels. At least one first parallel channel of the plurality of parallel channels is configured by an input sample whose interval with the output sample is zero.

In step SE13, at least a part of the plurality of parallel channels is input to each coefficient calculation unit 12E-i. At least some of the plurality of parallel channels input to the coefficient calculation unit 12E-i are parallel channels including surrounding samples of output samples to be calculated by the output signal calculation unit 13E-i associated with the coefficient calculation unit 12E-i.

In step SE14, each coefficient calculation unit 12E-i calculates a coefficient sequence based on the input surrounding input samples. The calculated coefficient sequence is input to the associated output signal calculation unit 13E-i.

In step SE15, each output signal calculation unit 13E-i calculates an output sample by using the input coefficient sequence, the surrounding input samples, and the input/output interval data of the pattern associated with the output sample to be calculated, which is calculated in advance.

In step SE16, the input samples included in the first parallel channel are output as output samples.

The output samples associated with the plurality of patterns are output by steps SE13 and SE16. Steps SE11 to SE16 are repeated to calculate the next calculation target output sample of each of the plurality of patterns. As a result, output samples are sequentially output to configure an output signal.

### Effects of Present Exemplary Embodiment

As described above, in the signal processing device 1E and the signal processing method SIE, the parallelization unit 14E that parallelizes the input signal into the plurality of parallel channels further includes the parallelization unit 14E that parallelizes at least one first parallel channel among the plurality of parallel channels in such a way that the at least one first parallel channel is configured by the input sample whose interval with the output sample is 0, the input sample included in the first parallel channel is output as the output sample, the coefficient calculation unit 12E-i calculates the coefficient sequence using the output sample whose interval with the input sample is other than 0 as the calculation target based on the surrounding input sample included in at least a part of the plurality of parallel channels, and the output signal calculation unit 13E-i calculates the output sample having an interval other than zero as a calculation target using input/output interval data and a coefficient sequence. As a result, according to the signal processing device 1E and the signal processing method SIE, the input signal is parallelized in the plurality of parallel channels in such a way as to be efficiently processed according to the number of patterns of the input/output interval data calculated and held in advance. Therefore, there is an effect that a plurality of patterns of output samples can be efficiently performed in parallel in the sample rate conversion processing. Since the first parallel channel is output as it is for at least one output sample of the plurality of patterns, calculation is not necessary. As a result, it is possible to further reduce the calculation amount required to convert the sample rate.

Since the number of parallel channels can be reduced as compared with a case where parallelization is performed such that all of a plurality of patterns are calculated based on surrounding input samples, an effect of contributing to reduction in circuit scale is further obtained. For example, in order to compare with the specific example (FIG. 21) of the signal processing device 1E, a comparative example in which parallelization is performed in such a way as to calculate all of the output samples 0 to 4 using surrounding input samples will be considered. In the comparative example, in order to calculate the output sample 4, it is necessary to use the channels CH7 to CH10 with the number of parallel channels being 10. In contrast to the comparative example, the specific example (FIG. 21) of the signal processing device 1E can reduce the circuit scale by reducing the number of parallel channels from 10 to 8.

The signal processing device 1E according to the present exemplary embodiment may be achieved by modifying the signal processing device 1B according to the third exemplary embodiment instead of modifying the signal processing device 1A according to the second exemplary embodiment. For example, the coefficient calculation unit 12E-i may be configured similarly to the coefficient calculation unit 12B.

### First Application Example

The signal processing device 1, 1A, 1B, 1C, or 1E according to each exemplary embodiment described above can be used for sampling rate conversion of a reception signal in an optical signal communication system using an optical fiber. The reception signal is an input signal to the signal processing device 1, 1A, 1B, 1C, or 1E.

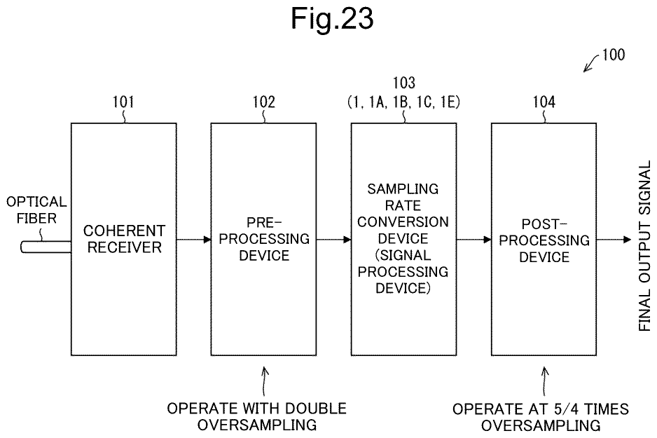

FIG. 23 is a block diagram illustrating a configuration of an optical signal communication system 100 in the present application example. As shown in FIG. 23, the optical signal communication system 100 includes a coherent receiver 101, a pre-processing device 102, a sampling rate conversion device 103, and a post-processing device 104.

The coherent receiver 101 outputs a reception signal by performing coherent detection on an optical signal output from the optical fiber.

The pre-processing device 102 operates, for example, at a double oversampling rate (an example of a first rate). The pre-processing device 102 performs pre-processing (for example, wavelength dispersion compensation, frame synchronization processing, and the like) on the reception signal input from the coherent receiver 101 to output a double oversampling signal.

As the sampling rate conversion device 103, the signal processing device 1, 1A, 1B, 1C, or 1E is applied. The sampling rate conversion device 103 executes the signal processing method S1, S1A, S1B, SIC, or SIE. As a result, the sampling rate conversion device 103 converts the double oversampled signal (an example of an input signal) input from the pre-processing device 102 into a fractional oversampled signal (an example of an output signal).

The post-processing device 104 operates at a fractional oversampling rate (an example of the second rate, for example, 5/4 times). The post-processing device 104 outputs a final output signal by performing post-processing on the fractional oversampled signal input from the sampling rate conversion device 103. Examples of the post-processing include adaptive equivalent processing and MIMO processing.

As described above, the signal processing device 1, 1A, 1B, 1C, or 1E and the signal processing method S1, S1A, S1B, S1C, or SIE are used for sampling rate conversion of a reception signal in the optical signal communication system 100 using an optical fiber, and have a configuration in which the reception signal is used as an input signal. Therefore, according to the signal processing device 1, 1A, 1B, 1C, or 1E and the signal processing method S1, S1A, S1B, SIC, or SIE, it is possible to reduce the calculation amount required for the sample rate conversion of the reception signal of the optical signal communication system. For example, in a case where pre-processing by general-purpose double oversampling and signal processing on a fractional oversampled signal are continuously performed on a reception signal of the optical signal communication system 100, it is possible to reduce the calculation amount required for the required sample rate conversion.

In the present application example, the pre-processing device 102 is not limited to the double oversampling rate, and may operate at another oversampling rate. The post-processing device 104 is not limited to operate at the 5/4 times oversampling rate, and may operate at another oversampling rate. In this case, the sampling rate conversion device 103 operates by applying the oversampling rate at which the pre-processing device 102 operates as the first rate and applying the oversampling rate at which the post-processing device 104 operates as the second rate.

The signal processing device 1, 1A, 1B, 1C, or 1E and the signal processing method S1, S1A, S1B, S1C, or SIE can be used not only for optical signal communication but also for sample rate conversion in other communication fields.

### Second Application Example

The signal processing device 1D according to the fifth exemplary embodiment can be used for sampling rate conversion of a reception signal in an optical signal communication system using an optical fiber having a plurality of propagation modes. For example, the signal processing device 1D is used in optical signal communication using polarization multiplexing in a single mode fiber. As the optical fiber having a plurality of propagation modes, a multi-core fiber may be used, or a multi-mode fiber for mode-multiplexed optical signal communication may be used. The signal processing device 1D may be used in an optical signal communication system adopting a multiplexing system in which these optical fibers are combined. The reception signal is an input signal to the signal processing device 1D.

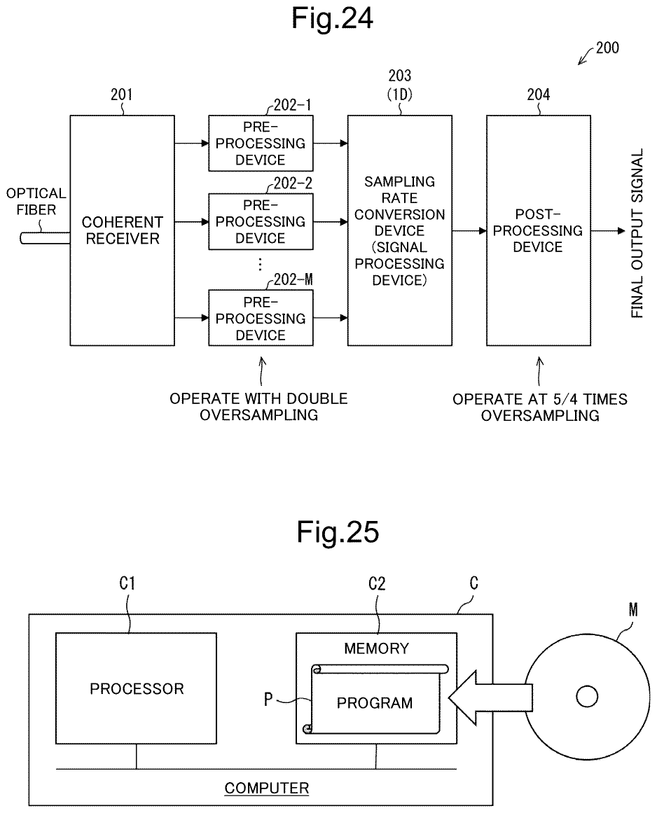

FIG. 24 is a block diagram illustrating a configuration of an optical signal communication system 200 in the present application example. As illustrated in FIG. 24, the optical signal communication system 200 includes a coherent receiver 201, a pre-processing device 202-i (i=1, 2, . . . , M), a sampling rate conversion device 203, and a post-processing device 204.

The coherent receiver 201 outputs the multiplexed reception signal i by performing coherent detection on the optical signal output from the optical fiber.

The pre-processing device 202-i operates, for example, at a double oversampling rate (an example of a first rate). The pre-processing device 202-i performs pre-processing (for example, wavelength dispersion compensation, frame synchronization processing, and the like) on the reception signal i input from the coherent receiver 201 to output the double oversampled signal i. A signal processing device 1D is applied as the sampling rate conversion device 203.

The sampling rate conversion device 203 executes the signal processing method SID. As a result, the sampling rate conversion device 203 converts the M double oversampled signals i (an example of a plurality of input signals) input from the M pre-processing devices 202-i into M fractional oversampled signals i (an example of a plurality of output signals).

The post-processing device 204 operates at a fractional oversampling rate (an example of the second rate, for example, 5/4 times). The post-processing device 204 outputs a final output signal by performing post-processing on the fractional oversampled signal input from the sampling rate conversion device 203. Examples of the post-processing include adaptive equivalent processing and MIMO processing.

As described above, the signal processing device 1D and the signal processing method SID are used for sampling rate conversion of a reception signal in the optical signal communication system 200 using an optical fiber having a plurality of propagation modes, and employ a configuration in which the reception signal is used as an input signal. Therefore, according to the signal processing device 1D and the signal processing method SID, it is possible to reduce the calculation amount required for sample rate conversion of the reception signal of the optical signal communication system having the plurality of propagation modes. For example, in a case where the pre-processing by the general-purpose double oversampling and the signal processing on the fractional oversampled signal are continuously performed on the multiplexed reception signal, it is possible to reduce the calculation amount required for the required sample rate conversion.

In the present application example, the pre-processing device 202-i is not limited to the double oversampling rate, and may operate at another oversampling rate. The post-processing device 204 is not limited to operate at the 5/4 times oversampling rate, and may operate at another oversampling rate. In this case, the sampling rate conversion device 203 operates by applying the oversampling rate at which the pre-processing device 202-i operates as the first rate and applying the oversampling rate at which the post-processing device 204 operates as the second rate.

The signal processing device 1D and the signal processing method SID are not limited to optical signal communication, and can be used for sample rate conversion in other communication fields.

### Example of Implementation by Software

Some or all of the functions of the signal processing devices 1, 1A, 1B, 1C, 1D, and 1E (hereinafter, also referred to as “each of the above devices”) may be implemented by hardware such as an integrated circuit (IC chip), may be implemented by software, or may be implemented by a combination of hardware and software.

In the case of being achieved by software, each of the above-described functions is achieved, for example, by a computer that executes a command of a program that is software for achieving the function. An example of such a computer (hereinafter, referred to as a computer C) is illustrated in FIG. 25. FIG. 25 is a block diagram illustrating a hardware configuration of a computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used.

The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers. [Supplementary Notes] The present disclosure includes the technologies described in the following Supplementary Notes. However, the present invention is not limited to the technologies described in the following Supplementary Notes, and various modifications can be made within the scope described in the claims.

### (Supplementary Note A1)

A signal processing method for converting an input signal sampled at a first rate into an output signal sampled at a second rate in a communication system, the signal processing method including:
input/output interval calculation processing of calculating input/output interval data related to a temporal interval between an input sample and an output sample adjacent in the input signal and the output signal, the input/output interval data being able to be shared in calculation of each output sample, based on the first rate and the second rate;
coefficient calculation processing of calculating a coefficient sequence used for calculation of an output sample to be calculated based on an input sample around the output sample; and
output signal calculation processing of calculating the output sample to be calculated using the input/output interval data and the coefficient sequence.

### (Supplementary Note A2)

The signal processing method according to Supplementary Note A1, in which
the output signal calculation processing uses a high-order polynomial that interpolates at least two input samples with a curve, and
the input/output interval calculation processing calculates an interval value indicating the interval and a power of the interval value included in the high-order polynomial as the input/output interval data.

### (Supplementary Note A3)

The signal processing method according to Supplementary Note A1 or A2, in which
the input/output interval calculation processing applies, as an interval between the input sample and the output sample adjacent to each other,
an interval between an output sample and an input sample immediately before the output sample, or
an interval between an output sample and an input sample immediately after the output sample.

### (Supplementary Note A4)

The signal processing method according to any one of Supplementary Notes A1 to A3, in which
the input/output interval calculation processing calculates data including a constant multiple of a value based on the interval as the input/output interval data, and
the constant is a number for reducing the number of times of multiplication other than an integer power of 2 in the coefficient calculation processing.

### (Supplementary Note A5)

The signal processing method according to any one of Supplementary Notes A1 to A4, in which
the input/output interval calculation processing calculates the input/output interval data for each of the intervals of a plurality of patterns, and
the output signal calculation processing selects input/output interval data used to calculate the output sample to be calculated from the input/output interval data of the plurality of patterns.

### (Supplementary Note A6)

The signal processing method according to any one of Supplementary Notes A1 to A5, in which
the input/output interval calculation processing calculates the input/output interval data for each of the intervals of N patterns (N is an integer of 2 or more), and
the output signal calculation processing includes
branch processing of inputting a coefficient sequence associated with the output sample to be calculated to any one of the calculation processing associated with the N patterns, and
calculation processing of calculating the output sample to be calculated using the input/output interval data of the associated pattern and the coefficient sequence input by the branch processing in each of the N patterns of calculation processing.

### (Supplementary Note A7)

A signal processing method according to any one of Supplementary Notes A1 to A6, for converting a sampling rate of each of the plurality of input signals input in parallel from the first rate to the second rate and outputting the plurality of output signals in parallel, in which
the input/output interval calculation processing is executed in common for a plurality of combinations of the input signals and the output signals, and
the coefficient calculation processing and the output signal calculation processing are executed in parallel for each of the plurality of combinations.

### (Supplementary Note A8)

The signal processing method according to any one of Supplementary Notes A1 to A7, further including parallelization processing of parallelizing the input signal into a plurality of parallel channels, the parallelization processing performing parallelization in such a way that at least one first parallel channel among the plurality of parallel channels is configured by an input sample having the interval of zero, in which
an input sample included in the first parallel channel is output as an output sample,
the coefficient calculation processing further calculates the coefficient sequence based on the surrounding input samples included in at least a part of the plurality of parallel channels, with the output samples having the interval other than zero as a calculation target, and
the output signal calculation processing further calculates the output sample to be calculated using the input/output interval data and the coefficient sequence.

### (Supplementary Note A9)

The signal processing method according to any one of Supplementary Notes A1 to A8, in which the signal processing method is used for sampling rate conversion of a reception signal in an optical signal communication system using an optical fiber, and the reception signal is used as the input signal.

### (Supplementary Note B1)

A signal processing device for converting an input signal sampled at a first rate into an output signal sampled at a second rate in a communication system, the signal processing device including:
input/output interval calculation means for calculating input/output interval data related to a temporal interval between an input sample and an output sample adjacent in the input signal and the output signal, the input/output interval data being able to be shared in calculation of each output sample, based on the first rate and the second rate;
coefficient calculation means for calculating a coefficient sequence used for calculation of an output sample to be calculated based on an input sample around the output sample; and
output signal calculation means for calculating the output sample to be calculated using the input/output interval data and the coefficient sequence.

### (Supplementary Note B2)

The signal processing device according to Supplementary Note B1, in which
the output signal calculation means uses a high-order polynomial that interpolates at least two input samples with a curve, and
the input/output interval calculation means calculates an interval value indicating the interval and a power of the interval value included in the high-order polynomial as the input/output interval data.

### (Supplementary Note B3)

The signal processing device according to Supplementary Note B1 or B2, in which
the input/output interval calculation means applies, as an interval between the input sample and the output sample adjacent to each other,
an interval between an output sample and an input sample immediately before the output sample, or
an interval between an output sample and an input sample immediately after the output sample.

### (Supplementary Note B4)

The signal processing device according to any one of Supplementary Notes B1 to B3, in which
the input/output interval calculation means calculates data including a constant multiple of a value based on the interval as the input/output interval data, and
the constant is a number for reducing the number of times of multiplication other than an integer power of 2 in the coefficient calculation means.

### (Supplementary Note B5)

The signal processing device according to any one of Supplementary Notes B1 to B4, in which
the input/output interval calculation means calculates the input/output interval data for each of the intervals of a plurality of patterns, and
the output signal calculation means selects input/output interval data used to calculate the output sample to be calculated from the input/output interval data of the plurality of patterns.

### (Supplementary Note B6)

The signal processing device according to any one of Supplementary Notes B1 to B5, in which
the input/output interval calculation means calculates the input/output interval data for each of the intervals of N patterns (N is an integer of 2 or more), and
the output signal calculation means includes
branch means for inputting a coefficient sequence associated with the output sample to be calculated to any one of the calculation means associated with the N patterns, and
calculation means for calculating the output sample to be calculated using the input/output interval data of the associated pattern and the coefficient sequence input by the branch means in each of the N patterns of calculation means.

### (Supplementary Note B7)

A signal processing device according to any one of Supplementary Notes B1 to B6, for converting a sampling rate of each of the plurality of input signals input in parallel from the first rate to the second rate and outputting the plurality of output signals in parallel, in which
the input/output interval calculation means is provided in common for a plurality of combinations of the input signals and the output signals, and
the coefficient calculation means and the output signal calculation means are provided in parallel for each of the plurality of combinations.

### (Supplementary Note B8)

The signal processing device according to any one of Supplementary Notes B1 to B7, further including parallelization means for parallelizing the input signal into a plurality of parallel channels, the parallelization means performing parallelization in such a way that at least one first parallel channel among the plurality of parallel channels is configured by an input sample having the interval of zero, in which
an input sample included in the first parallel channel is output as an output sample,
the coefficient calculation means calculates the coefficient sequence based on the surrounding input samples included in at least a part of the plurality of parallel channels, with the output samples having the interval other than zero as a calculation target, and
the output signal calculation means calculates the output sample to be calculated using the input/output interval data and the coefficient sequence.

### (Supplementary Note B9)

The signal processing device according to any one of Supplementary Notes B1 to B8, in which the signal processing device is used for sampling rate conversion of a reception signal in an optical signal communication system using an optical fiber, and the reception signal is used as the input signal.

### (Supplementary Note C1)

A signal processing circuit for converting an input signal sampled at a first rate into an output signal sampled at a second rate in a communication system, the signal processing circuit including:
an input/output interval calculation circuit for calculating input/output interval data related to a temporal interval between an input sample and an output sample adjacent in the input signal and the output signal, the input/output interval data being able to be shared in calculation of each output sample, based on the first rate and the second rate;
a coefficient calculation circuit for calculating a coefficient sequence used for calculation of an output sample to be calculated based on an input sample around the output sample; and
an output signal calculation circuit for calculating the output sample to be calculated using the input/output interval data and the coefficient sequence.

### (Supplementary Note D1)

A signal processing device for converting an input signal sampled at a first rate into an output signal sampled at a second rate in a communication system, the signal processing device including at least one processor, the at least one processor executing:
input/output interval calculation processing of calculating input/output interval data related to a temporal interval between an input sample and an output sample adjacent in the input signal and the output signal, the input/output interval data being able to be shared in calculation of each output sample, based on the first rate and the second rate;
coefficient calculation processing of calculating a coefficient sequence used for calculation of an output sample to be calculated based on an input sample around the output sample; and
output signal calculation processing of calculating the output sample to be calculated using the input/output interval data and the coefficient sequence.

The signal processing device may further include a memory. The memory may store a program for causing the at least one processor to execute each of the processing.

1. A signal processing method for converting an input signal sampled at a first rate into an output signal sampled at a second rate in a communication system, the signal processing method comprising:
input/output interval calculation processing of calculating input/output interval data related to a temporal interval between an input sample and an output sample adjacent in the input signal and the output signal, the input/output interval data being able to be shared in calculation of each output sample, based on the first rate and the second rate;
coefficient calculation processing of calculating a coefficient sequence used for calculation of an output sample to be calculated based on an input sample around the output sample; and
output signal calculation processing of calculating the output sample to be calculated using the input/output interval data and the coefficient sequence.

2. The signal processing method according to claim 1, wherein
the output signal calculation processing uses a high-order polynomial that interpolates at least two input samples with a curve, and
the input/output interval calculation processing calculates an interval value indicating the interval and a power of the interval value included in the high-order polynomial as the input/output interval data.

3. The signal processing method according to claim 1, wherein
the input/output interval calculation processing applies, as an interval between the input sample and the output sample adjacent to each other,
an interval between an output sample and an input sample immediately before the output sample, or
an interval between an output sample and an input sample immediately after the output sample.

4. The signal processing method according to claim 1, wherein
the input/output interval calculation processing calculates data including a constant multiple of a value based on the interval as the input/output interval data, and
the constant is a number for reducing the number of times of multiplication other than an integer power of 2 in the coefficient calculation processing.

5. The signal processing method according to claim 1, wherein
the input/output interval calculation processing calculates the input/output interval data for each of the intervals of a plurality of patterns, and
the output signal calculation processing selects input/output interval data used to calculate the output sample to be calculated from the input/output interval data of the plurality of patterns.

6. The signal processing method according to claim 1, wherein
the input/output interval calculation processing calculates the input/output interval data for each of the intervals of N patterns (N is an integer of 2 or more), and
the output signal calculation processing includes
branch processing of inputting a coefficient sequence associated with the output sample to be calculated to any one of the calculation processing associated with the N patterns, and
calculation processing of calculating the output sample to be calculated using the input/output interval data of the associated pattern and the coefficient sequence input by the branch processing in each of the N patterns of calculation processing.

7. The signal processing method according to claim 1, for converting a sampling rate of each of the plurality of input signals input in parallel from the first rate to the second rate and outputting the plurality of output signals in parallel, wherein
the input/output interval calculation processing is executed in common for a plurality of combinations of the input signals and the output signals; and
the coefficient calculation processing and the output signal calculation processing are executed in parallel for each of the plurality of combinations.

8. The signal processing method according to claim 1, further comprising parallelization processing of parallelizing the input signal into a plurality of parallel channels, the parallelization processing performing parallelization in such a way that at least one first parallel channel among the plurality of parallel channels is configured by an input sample having the interval of zero, wherein
an input sample included in the first parallel channel is output as an output sample,
the coefficient calculation processing further calculates the coefficient sequence based on the surrounding input samples included in at least a part of the plurality of parallel channels, with the output samples having the interval other than zero as a calculation target, and
the output signal calculation processing further calculates the output sample to be calculated using the input/output interval data and the coefficient sequence.

9. The signal processing method according to claim 1, wherein the signal processing method is used for sampling rate conversion of a reception signal in an optical signal communication system using an optical fiber, and the reception signal is used as the input signal.

10. A signal processing device for converting an input signal sampled at a first rate into an output signal sampled at a second rate in a communication system, the signal processing device comprising:
an input/output interval calculation circuit configured to calculate input/output interval data related to a temporal interval between an input sample and an output sample adjacent in the input signal and the output signal, the input/output interval data being able to be shared in calculation of each output sample, based on the first rate and the second rate;
a coefficient calculation circuit configured to calculate a coefficient sequence used for calculation of an output sample to be calculated based on an input sample around the output sample; and
an output signal calculation circuit configured to calculate the output sample to be calculated using the input/output interval data and the coefficient sequence.

11. The signal processing device according to claim 10, wherein
the output signal calculation circuit uses a high-order polynomial that interpolates at least two input samples with a curve, and
the input/output interval calculation circuit calculates an interval value indicating the interval and a power of the interval value included in the high-order polynomial as the input/output interval data.

12. The signal processing device according to claim 10, wherein
the input/output interval calculation circuit applies, as an interval between the input sample and the output sample adjacent to each other,
an interval between an output sample and an input sample immediately before the output sample, or
an interval between an output sample and an input sample immediately after the output sample.

13. The signal processing device according to claim 10, wherein
the input/output interval calculation circuit calculates data including a constant multiple of a value based on the interval as the input/output interval data, and
the constant is a number for reducing the number of times of multiplication other than an integer power of 2 in the coefficient calculation circuit.

14. The signal processing device according to claim 10, wherein
the input/output interval calculation circuit calculates the input/output interval data for each of the intervals of a plurality of patterns, and
the output signal calculation circuit selects input/output interval data used to calculate the output sample to be calculated from the input/output interval data of the plurality of patterns.

15. The signal processing device according to claim 10, wherein
the input/output interval calculation circuit calculates the input/output interval data for each of the intervals of N patterns (N is an integer of 2 or more), and
the output signal calculation circuit includes
a branch circuit configured to input a coefficient sequence associated with the output sample to be calculated to any one of the calculation circuit associated with the N patterns, and
a calculation circuit configured to calculate the output sample to be calculated using the input/output interval data of the associated pattern and the coefficient sequence input by the branch circuit in each of the N patterns of the calculation circuit.

16. The signal processing device according to claim 10, for converting a sampling rate of each of the plurality of input signals input in parallel from the first rate to the second rate and outputting the plurality of output signals in parallel, wherein
the input/output interval calculation circuit is provided in common for a plurality of combinations of the input signals and the output signals, and
the coefficient calculation circuit and the output signal calculation circuit are provided in parallel for each of the plurality of combinations.

17. The signal processing device according to claim 10, further comprising a parallelization circuit configured to parallelize the input signal into a plurality of parallel channels, the parallelization circuit performing parallelization in such a way that at least one first parallel channel among the plurality of parallel channels is configured by an input sample having the interval of zero, wherein
an input sample included in the first parallel channel is output as an output sample,
the coefficient calculation circuit calculates the coefficient sequence based on the surrounding input samples included in at least a part of the plurality of parallel channels, with the output samples having the interval other than zero as a calculation target, and
the output signal calculation circuit calculates the output sample to be calculated using the input/output interval data and the coefficient sequence.

18. The signal processing device according to claim 10, wherein
the signal processing device is used for sampling rate conversion of a reception signal in an optical signal communication system using an optical fiber, and the reception signal is used as the input signal.
